(19) United States
(12) Patent Application Publication
(10) Pub. No.: US 2017/0124489 A1
(43) Pub. Date: May 4, 2017

(54) Non-Scheduled Chartered Transportation Reservation Environment

(71) Applicant: EvoLux Transportation, LLC, Stamford, CT (US)

(72) Inventors: Raymond B. Leavitt, Stamford, CT (US); Matthew A. Lally, Weston, FL (US); Shayak Banerjee, Hartsdale, NY (US)

(21) Appl. No.: 15/315,859

(22) PCT Filed: Jun. 4, 2015
(86) PCT No.: PCT/US15/34172

§ 371 Date: Dec. 2, 2016

Related U.S. Application Data
(60) Provisional application No. 62/007,583, filed on Jun. 4, 2014.

(51) Int. Cl. G06Q 10/02; G06F 17/30

(52) U.S. Cl. CPC G06Q 10/02; G06F 17/30477; G06F 17/30554; G06Q 50/30

(57) ABSTRACT

Exemplary embodiments of the present disclosure provide for an electronic reservation environment connecting potential travelers with operators that provide non-scheduled chartered transportation. The electronic reservation environment can be programmed to accept aggregate booking requests from potential travelers to allow travelers to share non-scheduled chartered transportation. Shared transportation criteria can be specified to determine whether to present an aggregate booking request to an operator.

### CROSS REFERENCE TO RELATED APPLICATIONS

This application claims priority to U.S. Provisional Application No. 62/007,583, filed on Jun. 4, 2014, the disclosure of which is incorporated herein by reference in its entirety

### BACKGROUND

Operators of non-scheduled chartered fleets are highly underutilized. Often times, the costs of chartering transportation can be too expensive for individuals and/or accessibility to operators of chartered fleets can be limited. As a result, travelers typically rely on their own means of transportation or rely on scheduled, non-chartered transportation from service providers. What is needed is a non-scheduled charter transportation marketplace that aggregates demand and easily connects potential travelers with fleet operators to facilitate communication of real-time and future chartered assets inventory availability. What is further needed is the ability to book chartered transportation and aggregate demand to increase utilization of non-scheduled chartered transportation, which can reduce costs associated with chartered transportation options and increase usage of chartered transportation by individuals that may otherwise not utilize chartered transportation.

### SUMMARY

Exemplary embodiments of the present disclosure provide for an electronic reservation environment that forms a marketplace to connect potential travelers with operators of non-scheduled chartered transportations. The electronic reservation environment can be programmed and/or configured to allow the operators to manage and/or specify profile and fleet information and to allow the operators to manage booking requests from potential travelers. In exemplary embodiments, the electronic reservation environment aggregate demand for non-scheduled chartered transportation by allowing potential travelers to join booking requests created by other travelers (e.g., by allowing potential travelers to form a self-aggregated booking request before it is submitted to a chartered transportation operator).

In accordance with embodiments of the present disclosure, methods, non-transitory computer-readable media, and systems are disclosed for reserving non-scheduled chartered transportation. Aggregate booking requests can be created for non-scheduled chartered transportation in response to input from a first user received in an electronic reservation environment. Inputs from at least one other user in the electronic reservation environment can be received to allow the at least one other user to join the aggregate booking request to share the non-scheduled chartered transportation with the first user. The at least one other user can be associated with the aggregate booking request and a reservation for the non-scheduled chartered transportation can be generated based on the aggregate booking request.

In accordance with embodiments of the present disclosure, methods, non-transitory computer-readable media, and systems are disclosed for reserving non-scheduled chartered transportation. Shared transportation criteria associated with an aggregate booking request can be received in an electronic reservation environment including at least one computing device configured to process the shared transportation criteria. The aggregate booking can be distributed to others to invite other people to join the aggregated booking request and it can be determined whether the shared transportation criteria is satisfied. The aggregate booking request can be presented to an operator via a graphical user interface within the electronic reservation environment based on a determination that the shared transportation criteria has been satisfied.

In accordance with embodiments of the present disclosure, methods, non-transitory computer-readable media, and systems are disclosed for reserving non-scheduled chartered transportation. An electronic request to book chartered transportation can be received in an electronic reservation environment including at least one computing device configured to process the electronic request. Code can be executed to determine whether the electronic request is a request to share the chartered transportation with others. A first computer-implemented process can be executed in response to a determination that the electronic request is a request to share the chartered transportation with others and a second computer-implemented process can be executed in response to a determination that the electronic request is not a request to share the chartered transportation with others.

In accordance with embodiments of the present disclosure, methods, non-transitory computer-readable media, and systems are disclosed for reserving non-scheduled chartered transportation. Code can be executed to display graphical user interfaces to an operator in an electronic reservation environment and fleet information can be generated for the operator in response to inputs received from the operator via the graphical user interfaces. The fleet information can include vessel information for vessels operated by the operator. One or more booking requests can be presented to the operator via the graphical user interface. The booking requests can identify vessel information for one of the vessels included in the fleet information and an action can be performed in response to a disposition of the booking request by the operator.

In accordance with embodiments of the present disclosure, methods, non-transitory computer-readable media, and systems are disclosed for specifying an availability of a vessel or craft at a location. A graphical user interface can be displayed in an electronic reservation environment, and one or more locations from which a vessel or craft is available to be chartered can be received via the graphical user interface. A result to a search request for available vessels or crafts to charter can be generated that includes the vessel or craft based on the one or more locations received via the graphical user interface.

Any combination or permutation of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of a non-scheduled charter transportation reservation environment in accordance with exemplary embodiments of the present disclosure.

FIG. 2 is a block diagram of an exemplary embodiment of an administrator environment forming part of an exemplary embodiment of a non-scheduled charter transportation reservation environment in accordance with the present disclosure.

FIG. 3 is a block diagram of an exemplary embodiment of an operator environment forming part of an exemplary embodiment of a non-scheduled charter transportation reservation environment in accordance with the present disclosure.

FIG. 4 is a block diagram of an exemplary embodiment of a member environment forming part of an exemplary embodiment of a non-scheduled charter transportation reservation environment in accordance with the present disclosure.

FIG. 5 is a block diagram of an exemplary computing device for implementing embodiments of the present disclosure.

FIG. 6 is a block diagram of an exemplary client-server environment for implementing embodiments of an exemplary embodiment of a non-scheduled charter transportation reservation environment in accordance with the present disclosure.

FIG. 7 is an exemplary graphical user interface that can be provided by an exemplary embodiment of the present disclosure to facilitate viewing landing site information within an exemplary embodiment of a non-scheduled charter transportation reservation environment.

FIG. 8 is an exemplary graphical user interface that can be provided by an exemplary embodiment of the present disclosure to facilitate adding and/or editing landing site information within an exemplary embodiment of a non-scheduled charter transportation reservation environment.

FIG. 9 is an exemplary graphical user interface that can be provided by an exemplary embodiment of the present disclosure to facilitate managing operator information within an exemplary embodiment of a non-scheduled charter transportation reservation environment.

FIG. 10 is an exemplary graphical user interface that can be provided by an exemplary embodiment of the present disclosure to facilitate viewing of operator information within an exemplary embodiment of a non-scheduled charter transportation reservation environment.

FIGS. 11A and 11B depict an exemplary graphical user interface that can be provided by an exemplary embodiment of the present disclosure to facilitate specifying operator information within an exemplary embodiment of a non-scheduled charter transportation reservation environment.

FIG. 12 is an exemplary graphical user interface that can be provided by an exemplary embodiment of the present disclosure to facilitate viewing aircraft information within an exemplary embodiment of a non-scheduled charter transportation reservation environment.

FIG. 13 is an exemplary graphical user interface that can be provided by an exemplary embodiment of the present disclosure to facilitate adding and/or editing aircrafts within an exemplary embodiment of a non-scheduled charter transportation reservation environment.

FIG. 14 is an exemplary graphical user interface that can be provided by an exemplary embodiment of the present disclosure to facilitate management of bookings within an exemplary embodiment of a non-scheduled charter transportation reservation environment.

FIG. 15 is an exemplary graphical user interface that can be provided by an exemplary embodiment of the present disclosure to facilitate viewing of booking information included in an exemplary embodiment of a non-scheduled charter transportation reservation environment for an aggregate booking request associated with shared non-scheduled chartered transportation.

FIG. 16 is an exemplary graphical user interface that can be provided by an exemplary embodiment of the present disclosure to facilitate viewing of booking information included in an exemplary embodiment of a non-scheduled charter transportation reservation environment for a non-aggregate booking request associated with chartering an entire aircraft.

FIG. 17 is an exemplary graphical user interface that can be provided by an exemplary embodiment of the present disclosure to facilitate management of an operators bookings and profile within an exemplary embodiment of a non-scheduled charter transportation reservation environment.

FIG. 18 is an exemplary graphical user interface that can be provided by an exemplary embodiment of the present disclosure to facilitate adding aircrafts to and/or editing aircrafts in an operator's fleet within an exemplary embodiment of a non-scheduled charter transportation reservation environment.

FIG. 19 is an exemplary graphical user interface that can be provided by an exemplary embodiment of the present disclosure to allow a member to create and/or edit a member profile.

FIG. 20 is an exemplary graphical user interface that can be provided by an exemplary embodiment of the user interface to facilitate searching, viewing, and/or interacting with a potential shared flight reservation in accordance with the present disclosure.

FIG. 21 is another exemplary graphical user interface that can be provided by an exemplary embodiment of the user interface to facilitate searching, viewing, and/or interacting with potential shared flight reservations in accordance with the present disclosure.

FIG. 22 is an exemplary graphical user interface that can be provided by an exemplary embodiment of the present disclosure to display aggregate booking requests.

FIG. 23 is an exemplary graphical user interface that can be provided by an exemplary embodiment of the user interface to facilitate interacting with search results in accordance with the present disclosure.

FIG. 24 is another exemplary graphical user interface that can be provided by an exemplary embodiment of the present disclosure to facilitate interacting with search results in accordance with an exemplary embodiment of a non-scheduled charter transportation reservation environment.

FIG. 25 is an exemplary graphical user interface that can be provided by an exemplary embodiment of the present disclosure to facilitate receipt of booking information within an exemplary embodiment of a non-scheduled charter transportation reservation environment.

FIG. 26 is an exemplary graphical user interface that can be provided by an exemplary embodiment of the present disclosure to facilitate receipt of payment information within an exemplary embodiment of a non-scheduled charter transportation reservation environment.

FIG. 27 is an exemplary graphical user interface that can be provided by an exemplary embodiment of the present disclosure to facilitate display of booking and payment information for confirmation within an exemplary embodiment of a non-scheduled charter transportation reservation environment.

FIG. 28 is an exemplary graphical user interface that can be provided by an exemplary embodiment of the present disclosure to facilitate receipt of shared transportation criteria within an exemplary embodiment of a non-scheduled charter transportation reservation environment.

FIG. 29 is an exemplary graphical user interface that can be provided by an exemplary embodiment of the present disclosure to facilitate booking a shared non-scheduled charter flight in accordance with an exemplary embodiment of a non-scheduled charter transportation reservation environment.

FIG. 30 is another exemplary graphical user interface that can be provided by an exemplary embodiment of the present disclosure to facilitate booking a shared non-scheduled charter flight in accordance with an exemplary embodiment of a non-scheduled charter transportation reservation environment.

FIG. 31 is another exemplary graphical user interface that can be provided by an exemplary embodiment of the present disclosure to facilitate booking a shared non-scheduled charter flight in accordance with an exemplary embodiment of a non-scheduled charter transportation reservation environment.

FIG. 32 is an exemplary graphical user interface that can be provided by an exemplary embodiment of the present disclosure to facilitate creating, viewing, and/or joining an aggregate booking request in accordance with an exemplary embodiment of a non-scheduled charter transportation reservation environment.

FIG. 33 is an exemplary graphical user interface that can be provided by an exemplary embodiment of the present disclosure to facilitate viewing, monitoring, and/or joining an aggregate booking request in accordance with an exemplary embodiment of a non-scheduled charter transportation reservation environment.

FIG. 34 is an exemplary graphical user interface that can be provided by an exemplary embodiment of the present disclosure to facilitate monitoring of aggregate booking requests within an exemplary embodiment of a non-scheduled charter transportation reservation environment.

FIG. 35 is an exemplary graphical user interface that can be provided by an exemplary embodiment of the present disclosure to facilitate receipt of information from a member joining an aggregate booking request within an exemplary embodiment of a non-scheduled charter transportation reservation environment.

FIGS. 36 is exemplary graphical user interfaces that can be provided by an exemplary embodiment of the present disclosure to facilitate joining an existing aggregate booking request within an exemplary embodiment of a non-scheduled charter transportation reservation environment.

FIGS. 37A-C are flowcharts showing an exemplary booking processes that can be implemented in accordance with exemplary embodiments of the present disclosure.

FIG. 38 is a flowchart showing an exemplary search result generation process that can be implemented in accordance with exemplary embodiments of the present disclosure.

FIG. 39 is a flowchart showing an exemplary booking process that can be implemented in accordance with exemplary embodiments of the present disclosure.

### DESCRIPTION OF EXEMPLARY EMBODIMENTS

Exemplary embodiments of the present disclosure relate to an environment programmed and/or configured to create a charter marketplace that allows travelers to charter an entire vessel, craft, or vehicle (e.g., via a non-aggregate booking request) and/or to charter one or more seats on the vessel, craft, or vehicle using per-seat reservations (e.g., allowing travelers to self-aggregate to form an aggregate booking request). The marketplace can allow travelers to compare available vessels, crafts, or vehicles being offered by operators and to allow user to share their intent to book non-scheduled charter transportation with others through the marketplace or other social media networks. Exemplary embodiments of the present disclosure advantageously provide for socializing private (chartered) travel to make private (chartered) travel more accessible and affordable as an alternative mode of transportation.

As used herein, the term “charter” refers to the reservation of vehicle or vessel, such as an aircraft, a boat, a bus, a limousine, and the like, for private non-scheduled use.

As used herein, the term “non-scheduled chartered transportation” refers to chartered transportation that is provided upon request by one or more potential travelers (e.g., on-demand transportation).

In one exemplary implementation, the charter marketplace can be a helicopter charter marketplace that allows travelers to book charter helicopter trips based on an availability of a helicopter operator. The marketplace can allow travelers to specify helicopter friendly landing areas for departure and/or arrival locations, such as heliports, airports, hotels with landing pads, golf courses, vineyards, cruise boats or yachts, and/or any other locations where helicopters can safely take off and land. Travelers can share a chartered helicopter with other travelers and/or can charter the entire helicopter. When the traveler shares the chartered helicopter with other travelers, the user can specify shared flight criteria that must be satisfied before the traveler commits and pays to charter the helicopter. The traveler may also determine how and to whom the flight is shared, for example, by controlling where the shared flight information is disseminated.

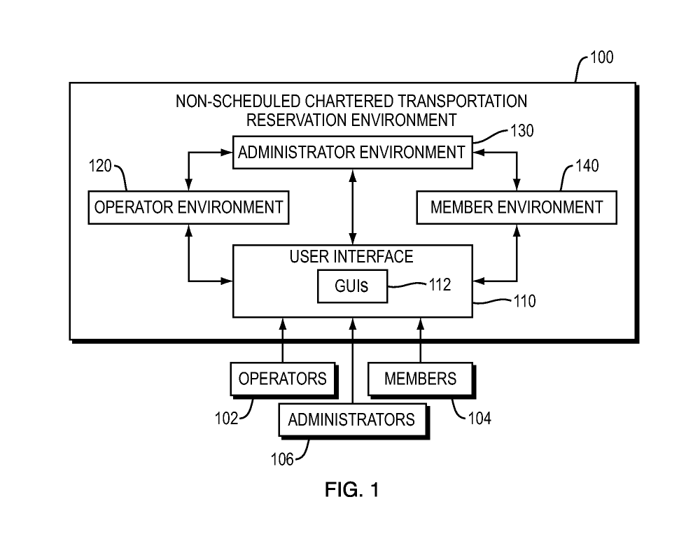

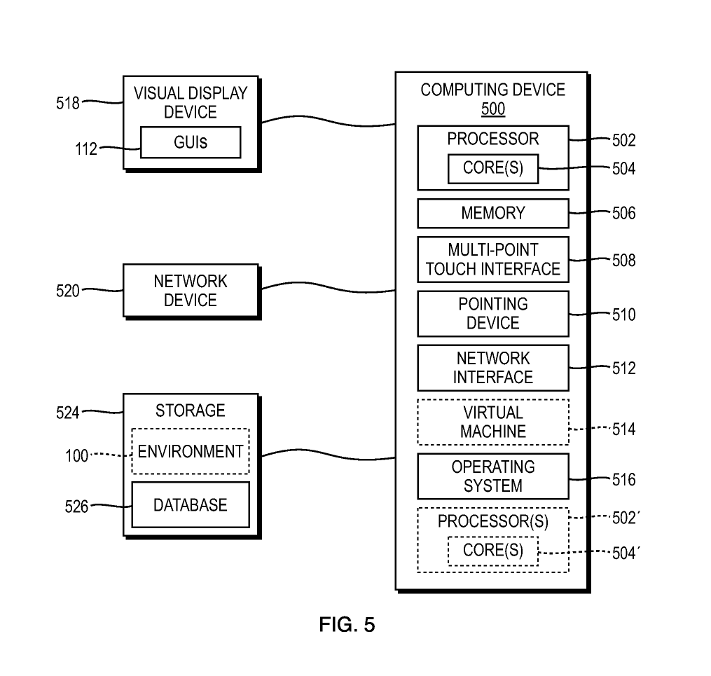

FIG. 1 is a block diagram of an exemplary non-scheduled charter transportation reservation environment 100 in accordance with exemplary embodiments of the present disclosure. The environment 100 can form a marketplace between operators 102 (e.g., transportation providers) and members 104 of the marketplace (e.g., customers, travelers, etc.) that allows the operators 102 to provide transportation options to the members 104 and allows the members 104 to search, view, share, and/or book non-scheduled chartered transportation. Administrators 106 control and/or manage information/data that is provided to and/or received from the operators 102 and members 104. Exemplary embodiments of the environment 100 can be implemented using hardware, software, and/or a combination thereof. For example, in one exemplary embodiment, one or more computing devices can be programmed and/or configured to implement exemplary embodiments of the environment 100. An exemplary embodiment of a computing device configured to implement embodiments of the environment 100, or portions thereof, is shown, for example, in FIG. 5. The environment 100 can include a user interface 110, an administrator environment 120, an operator environment 130, and a member environment 140. The environment 100 can be programmed and/or include executable code to implement one or more processes to facilitate processing inputs received from users (e.g., members, fleet operators, and administrators), booking one or more non-scheduled charters to one or more destinations, providing intermediary services between members and fleet operators, and/or further processes described herein.

The user interface 110 can be programmed and/or configured to provide one or more graphical user interfaces (GUIs) 112 through which users of the environment 100 (e.g., members, operators, and administrators) can interact with the environment 100. In exemplary embodiments, the user interface 110 can provide an interface between the users and the environments 120, 130, and 140. The GUIs 112 can be rendered on display devices and can include data output areas to display information to the users as well as data entry areas to receive information from the users. For example, data output areas of the GUIs 112 can output information associated with non-scheduled chartered transportation to the users via the data outputs and the data entry areas of the GUIs 112 can receive, for example, information associated with non-scheduled transportation requests from the members 104. Some examples of data output areas can include, but are not limited to text, graphics (e.g., graphs, maps (geographic or otherwise), images, and the like), and/or any other suitable data output areas. Some examples of data entry fields can include, but are not limited to text boxes, check boxes, buttons, dropdown menus, and/or any other suitable data entry fields.

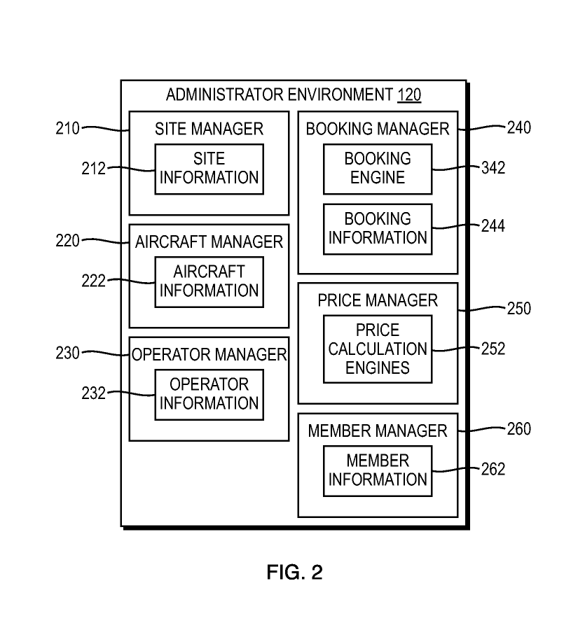

Referring to FIGS. 1 and 2, the administrator environment 120 can be programmed and/or configured to communicate with the user interface 110 to allow one or more administrators to interact with the administrator environment 120 (e.g., via the GUIs 112). In exemplary embodiments, the administrator environment 120 can be programmed and/or configured to facilitate the management and/or generation of data associated with landing sites, types of aircrafts, operator information, non-aggregate booking requests, aggregate booking requests, bookings/reservations, prices, and member information. As shown in FIG. 2, the administrator environment 120 can include a site manager 210, an aircraft manager 220, an operator manager 230, a booking manager 240, a price manager 250, and a member manager 260.

The site manager 210 can be programmed and/or configured to allow an administrator to specify, edit, and/or delete available landing site information 212 for aircrafts. The landing site information 212 for aircrafts can include, for example, a name of the landing site, a geographic location of the landing site (e.g., specified using longitude and latitude), a unique identifier associated with the landing site, and/or any other suitable landing site information. The landing site information 212 specified via the site manager 210 can be stored in one or more databases to facilitate structured searching for the site landing information 212 and/or to facilitate associations between the landing site information 212 and other information maintained by the environment 100, such as, for example, operator information and/or member information, as described herein.

The aircraft manager 220 can be programmed and/or configured to allow an administrator to specify, edit, and/or delete aircraft information 222. For each aircraft included in the aircraft information 222, the aircraft manager 220 can allow an administrator to specify a model name of the aircraft, a flight range associated the aircraft, a cruise speed of the aircraft, a maximum number of passengers the aircraft can transport, a fuel capacity of the aircraft, and/or any other suitable aircraft information. The aircraft information 222 specified via the aircraft manager 220 can be stored in one or more databases to facilitate structured searching for the aircraft information 222 and/or to facilitate associations between the aircraft information 222 and other information maintained by the environment 100, such as, for example, operator information and/or member information, as described herein.

The operator manager 230 can be programmed and/or configured to allow an administrator to specify, edit, and/or delete operator information 232. For each operator associated with the environment 100, the operator information 232 can include, for example, a name of the operator, a point of contact for the operator, a location of the operator, a quantity of pilots associated with the operator, a quantity of aircrafts associated with the operator, certifications held by the operator, a safety rating associated with the operator, a description of the operator, an availability of the aircrafts associated with the operator, insurance information for the operator, exclusive landing permissions held by the operator, and/or any other suitable operator information. The operator information 232 managed via the operator manager 220 can be stored in one or more databases to facilitate structured searching for the operator information 232 and/or to facilitate associations between the operator information 232 and other information maintained by the environment 100, such as, for example, landing site information, aircraft information, and/or member information as described herein.

The booking manager 240 can be programmed and/or configured to facilitate booking of non-scheduled charter transportation by a member of the environment 100 and/or can be programmed and/or configured to manage bookings of non-scheduled charter transportation. In exemplary embodiments, the booking manager 240 can include a booking engine 242 that is configured to generate booking information in response to inputs received by the environment 100 from members. For example, the booking engine 242 can be programmed and/or configured to receive an electronic booking request from a member via an interaction between the user interface 110 and the member environment 140. The electronic request can include booking information 244, such as an identifier associated with the member, a name of an operator, a departure location (or identifier associated therewith), a destination location (or an identifier associated therewith), a requested departure time, a number of passengers, whether the member intends to charter the entire aircraft or share the chartered aircraft with others, and/or any other suitable information. Using this booking information 244, the booking engine 242 can generate a booking request (e.g., a non-aggregate booking request or an aggregate booking request) for confirmation by the operator identified in the booking request. In some embodiments, the booking engine 242 can be programmed and/or configured to group booking requests by a status associated with the booking requests and/or can be programmed and/or configured to distinguish between booking requests to charter an entire aircraft (e.g., non-aggregate booking requests) and booking requests to share a chartered aircraft with others (e.g., aggregate booking requests).

The booking engine 242 is programmed and/or configured to generate a reservation for a chartered aircraft in response to a confirmation received from an operator for a booking request (e.g., a non-aggregate booking request or an aggregate booking request). In exemplary embodiments, the booking engine 242 can implement a booking process to receive booking information from one or more members for a chartered aircraft and to arrange a non-scheduled chartered flight with the operator before providing a firm confirmation that the aircraft has been reserved for non-scheduled chartered transportation. For example, the booking engine 242 can be programmed and/or configured to receive passenger information and payment information from each passenger for a booking request. In some embodiments, the booking engine 242 can be process this information to determine whether to present an operator with a booking request for the aircraft. In some embodiments, the booking engine can determine whether to present an operator with a booking request for an aircraft based on whether the load (e.g., passengers, cargo, and/or fuel weight) is within a capacity rating of the aircraft selected for the proposed flight.

The price manager 250 can be programmed and/or configured to generate and/or manage one or more prices associated with chartering an aircraft. In exemplary embodiments, the price manager 250 can include one or more price calculation engine(s) 252. The price calculation engine 252 can be programmed and/or configured to determine a price of chartered flights using one or more algorithms. In exemplary embodiments, the price calculation engines 252 can determine the price of a requested chartered flight by determining physical parameters associated with the flight, such as weight of the passengers (which may include any luggage), a weight of the fuel, a distance of the flight, a speed (e.g., a cruising speed) at which the aircraft travels, and the like. In some embodiments, the price calculation engines 252 can dynamically calculate the price of flights to revise the price of the requested chartered flight based on changes in the physical parameters associated with the flight. In exemplary embodiments, the price calculation engines 252 can be programmed and/or configured to include a single-leg price calculation algorithm that can be used by the price calculation engine 252 to determine a price of a single leg flight (e.g., a one-way flight) and to include a multi-leg price calculation algorithm that can be used by the engine 252 to determine a price for a multi-leg flight (e.g., a round trip flight).

The member manager 260 can be programmed and/or configured to allow an administrator to specify, edit, and/or delete member information 262. For each member associated with the environment 100, the member information 262 can include, for example, a name of the member, an e-mail address associated with the member, a phone number associated with the member, a height of the member, a weight of the member, whether the member wishes to receive shared flight notifications, travel interests (e.g., business, personal, both), preferred departure and/or destination locations, payment information (e.g. credit card numbers), preferred aircraft types or models, preferred operators, and/or any other suitable operator information. The member information 262 managed via the member manager 260 can be stored in one or more databases to facilitate structured searching for the member information 262 and/or to facilitate associations between the member information 262 and other information maintained by the environment 100, such as, for example, landing site information, aircraft information, and/or operator information, as described herein.

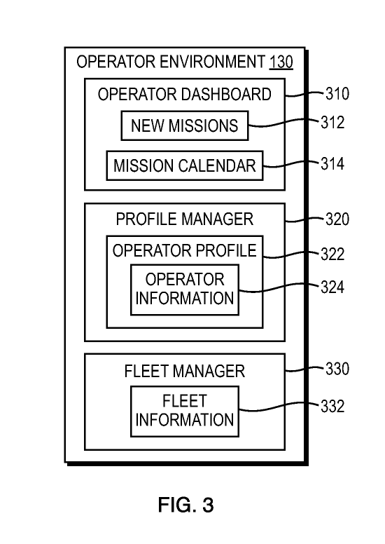

Referring to FIGS. 1 and 3, the operator environment 130 can be programmed and/or configured to communicate with the user interface 110 to allow one or more operators to interact with the operator environment 130 (e.g., via the GUIs 112). In exemplary embodiments, the operator environment 130 can be programmed and/or configured to facilitate managing chartered flight requests, operator information, and fleet information. As shown in FIG. 3, the operator environment 130 can include an operator dashboard engine 310, a profile manager 320, and a fleet manager 330.

The operator dashboard engine 310 can be programmed and/or configured to provide a portal through which operators' can manage their data/information in the operator environment 130. For example, the operator dashboard engine 310 can interface with one or more of the GUIs 112 that can be generated by the user interface 110 to allow the operators to view, input, and/or modify data/information associated with the operator. In exemplary embodiments, the operator dashboard engine 310 can receive booking requests (e.g., a non-aggregate booking request or an aggregate booking request) submitted by members and initiate one or more actions in response to the booking requests including, for example, accepting the requests, denying the requests, shifting departure times associated with the requests, and/or any other suitable actions. After a booking request is accepted by an operator, the operator dashboard engine 310 can be executed to allow the operator to initiate one or more actions with respect to an accepted chartered flight, such as delay the flight, cancel the flight, indicate that the flight will take off on time, and/or any other suitable actions. In exemplary embodiments, the operator dashboard engine 310 can be programmed and/or configured to output information to one or more of the GUIs 112 regarding temporary flight restrictions, weather information, regional aviation information, and the like, to provide the operator with information that may impact a chartered flight.

The profile manager 320 can be programmed and/or configured to allow an operator to create, update, modify, and/or delete an operator profile 322 associated with the operator's account in the environment 130. The operator profile can be specified by the operator to include operator information 324, such as a name of the operator, a point of contact for the operator, a location of the operator, a quantity of pilots associated with the operator, a quantity of aircrafts associated with the operator, certifications held by the operator, a safety rating associated with the operator, a description of the operator, an availability of the aircrafts associated with the operator, insurance information for the operator, exclusive landing permissions held by the operator, and/or any other suitable operator information. The operator information 324 specified via the profile manager 320 can be stored in one or more databases to facilitate structured searching for the operator information 324 and/or to facilitate associations between the operator information 324 and other information maintained by the environment 100, such as, for example, landing site information, aircraft information, and/or member information, as described herein.

The fleet manager 330 can be programmed and/or configured to allow an operator to specify fleet information 332 in the environment 130. The fleet information can be specified by the operator to include names, images, and/or model types of aircrafts associated with the operator; a home location of the aircraft; capabilities and/or amenities associated with the aircrafts; operational details of the aircrafts; rates and fees associated with the aircraft; and/or any other suitable fleet information. The fleet information 332 specified via the fleet manager 330 can be stored in one or more databases to facilitate structured searching for the fleet information 332 and/or to facilitate associations between the fleet information 332 and other information maintained by the environment 100, such as, for example, operator information, landing site information, and/or member information, as described herein.

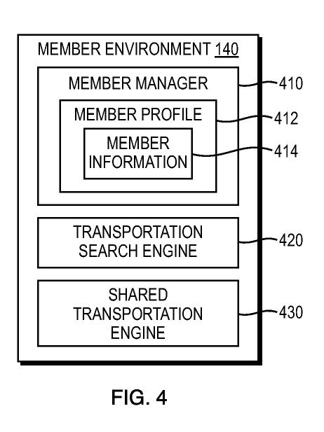

Referring to FIGS. 1 and 4, the member environment 140 can be programmed and/or configured to communicate with the user interface 110 to allow one or more members to interact with the member environment 140 (e.g., via the GUIs 112). In exemplary embodiments, the member environment 140 can be programmed and/or configured to facilitate managing member profile information; searching for available aircrafts to charter; generating booking requests (e.g., a non-aggregate booking request or an aggregate booking request) to request chartered transportation from operators; and/or joining already existing aggregate booking requests. Aggregate booking requests may also be referred to herein as shared transportation requests, and are booking requests that allow a member to share chartered transportation with others such that the booking of non-scheduled chartered transportation can be aggregated. In exemplary embodiments, once an aggregate booking request is created by a member, the aggregate booking request can be shared with others to invite people to join the aggregate booking request on a per seat basis. Non-aggregate booking requests may be referred to herein as single member booking requests, and are booking requests for chartered transportation received from a single member. In exemplary embodiments, once a non-aggregate booking request is created the request can be submitted to an operator of the chartered transportation to facilitate booking the chartered transportation. As shown in FIG. 4, the member environment 140 can include a profile manager 410, a transportation search engine 420, and a shared transportation engine 430.

The profile manager 410 can be programmed and/or configured to allow a member to create, update, modify, and/or delete a member profile 412 for a member account in the environment 140. The member profile 412 can be specified by the member to include member information 414, such as, for example, a name of the member, an e-mail address associated with the member, a phone number associated with the member, a height of the member, a weight of the member, whether the member wishes to receive shared flight notifications, travel interests (e.g., business, personal, both), preferred departure and/or destination locations, payment information (e.g. credit card numbers), preferred aircraft types or models, preferred operators, previous searches performed by the member in the environment 100, and/or any other suitable operator information. The member information 414 specified via the profile manager 410 can be stored in one or more databases to facilitate structured searching for the member information 414 and/or to facilitate associations between the member information 414 and other information maintained by the environment 100, such as, for example, landing site information, aircraft information, and/or operator information, as described herein.

The transportation search engine 420 can be programmed and/or configured to receive search criteria from a member (e.g., via the user interface 110), to construct one or more queries that can be used to retrieve operator information from a database, and to facilitate rendering the search results in one of the GUIs 112 to present the search results to the member. In some embodiments, the search engine 420 can search multiple database for operator information. The operator information retrieved by the search engine 420 can include be used by the search engine 420 to generate results based on an availability of aircraft associated with the operators for the departure location, destination location(s), and departure times specified by the member in the search criteria. The results can include prices associated with the aircrafts; aircraft types or classes available for chartering; operators of the aircrafts; location information for the aircrafts for the specified departure location and time; and the like. The retrieved operator information can be used to populate one of the GUIs 112 and can be used by the search engine 420 to associate a location of the aircrafts returned by the search with a geographic map, as described herein.

The shared transportation engine 430 can be programmed and/or configured to create and manage shared transportation criteria. For example, in exemplary embodiments, when members identify an aircraft they wish to charter, the members can specify that they wish to charter the entire aircraft or that they wish to charter individual seats on the aircraft, while sharing any remaining seats with other members. A member may choose to share a chartered aircraft for several reasons. For example, in exemplary embodiments, by sharing a flight, a member is no longer solely responsible for paying the total cost of the flight. Rather, the potential cost of the flight can be distributed across multiple members interested in the flight selected by the member; thereby aggregating demand of aircraft for non-scheduled chartered transportation. This aggregation of demand can advantageously increase utilization of chartered transportation and can reduce costs to individuals utilizing chartered transportation.

When a member chooses to create an aggregate booking request (or shared transportation request), the engine 430 is programmed and/or configured to receive shared flight criteria from the member. The shared flight criteria can advantageously allow members the flexibility to set their per-seat price goal during selection of aircraft to charter. The shared flight criteria can include one or more criteria that must be satisfied before the member commits to the shared flight. Some examples of shared flight criteria can include a minimum number of passengers, a maximum price per seat, a deadline by which the other criteria must be satisfied, and the like. In some embodiments, the shared flight criteria be modified and/or changed during the pendency of the aggregate booking request. The engine 430 can be executed (e.g. by a processing device) to determine whether the shared flight criteria has been satisfied within a specified deadline and can perform one or more tasks in response to the determination. As one example, if the engine 430 determines that the shared flight criteria is not satisfied (e.g., a threshold number of passengers have not joined the shared flight) by the specified deadline, the engine 430 can be executed to cancel the shared flight. As another example, if the engine 430 determines that the shared flight criteria has been satisfied (e.g., a threshold number of passengers have joined the shared flight) prior to the specified deadline, the engine 430 can be executed to facilitate booking and confirmation of the flight with the operator for the flight and can facilitate collecting the fees from the members and the notifying the members that the shared flight requirements have been satisfied.

In exemplary embodiments, the engine 430 can be programmed and/or configured to facilitate and promote social interaction. For example, when a member creates an aggregate booking request, the engine 430 can be programmed and/or configured to enable the member to determine with whom the aggregate booking request is shared. As one example, the member can create an aggregate booking request that can be share the flight with others through the environment 100 (i.e. members) so that only people that have an account with the environment 100 or a subset of the people that have an account with the environment 100 can see the aggregate booking request. As another example, the member can share the aggregate booking request through an external social media site (e.g., Facebook, Twitter, Google+, LinkedIn, etc.) with which the member has an account so that the members contacts on the social media sites (e.g., friends, followers, connections, etc.) can be notified of the aggregate booking request. As yet another example, the member can share the aggregate booking request by sending e-mails to others. The engine 430 can also be programmed and/or configured to allow social interaction through comment or feed associated with aggregate booking request, such that members that create, view, join or share the aggregate booking request can post comments that can be displayed in a GUI that displays information associated with the aggregate booking request.

In some embodiments, each member that creates and/or joins an aggregate booking request can specify shared flight criteria (e.g., a goal or threshold for the number of passengers before the member commits to the shared flight) such that the shared flight criteria specified by each of the members must be satisfied by the shared flight is booked and scheduled. Generally, the more passengers that join the aggregate booking request, the lower the price per seat for each passenger. As one example, a member may wish to reduce the cost of a flight by sharing the aggregate booking request with their social network as described herein (e.g., through the environment, e-mail, or one or more social media networks, such as Facebook, Twitter, Google+, LinkedIn) and specifying in the environment 100 a threshold of 2 passengers for the shared flight. In this example, the cost of the shared flight can be shared by the passengers of the shared flight.

By allowing the member to share aggregate booking request with others, the environment 100 can advantageously improve utilization of aircrafts for charter flights and/or reduce costs for members who wish to charter a flight (e.g., by aggregating demand for non-stop chartered flights). Because the engine 430 is programmed to allow the member to determine how aggregate booking request is shared, the member can control who can join the shared flight. Additionally, because the engine 430 is programmed to respond to shared flight criteria, the member is not obligated to commit to paying the total cost of the flight in no other members joint the member's shared flight.

In some embodiments, the environment 100 can integrate and/or be in communication with other booking/reservation services to provide members with the ability to book/reserve non-transportation related items through the environment 100. For example, in some embodiments, the environment 100 can be programmed and/or configured to allow the members to book/reserve hotel rooms, dinner reservations, golf tee times, entertainment events, sporting events, and the like. This can allow the members to book non-scheduled charter transportation to a destination location and can book the non-transportation related items during the same session.

While an exemplary embodiment of the environment 100 has been illustrated with the administrative environment 120, operator environment 130, and environment 140 as separate environments, as shown in FIGS. 1-4, those skilled in the art will recognize that one or more of these environments or components thereof can be integrated with each other. Furthermore, while an exemplary embodiment of the environment 100 includes the environments 120, 130, and 140, those skilled in the art will recognize that different embodiments can include more or fewer components and/or that each of the environment 120, 130, and/or 140 can include a separate user interface. Exemplary processes and operations of the environments 120, 130, and 140 are further described with respect to FIGS. 5-41 below.

FIG. 5 is a block diagram of an exemplary computing device 500 that may be used to implement exemplary embodiments of the environments 100 described herein. The computing device 500 includes one or more non-transitory computer-readable media for storing one or more computer-executable instructions or software for implementing exemplary embodiments of the environment 100 or portions thereof. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions, code or software for implementing exemplary embodiments of the environments 100 or portions thereof. The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions, code, or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, MRAM, EDO RAM, and the like. Memory 506 may include other types of memory as well, or combinations thereof.

A user may interact with the computing device 500 through a visual display device 518, such as a computer monitor, which may be operatively coupled, indirectly or directly, to the computing device 500 to display one or more of the graphical user interfaces 112 that can be provided in accordance with exemplary embodiments. The computing device 500 may include other I/O devices for receiving input from a user, for example, a keyboard or any suitable multi-point touch interface 508, and a pointing device 510 (e.g., a mouse). The keyboard 508 and the pointing device 510 may be coupled to the visual display device 518. The computing device 500 may include other suitable conventional I/O peripherals.

The computing device 500 may also include or be operatively coupled to one or more storage devices 524, such as a hard-drive, CD-ROM, or other computer readable media, for storing data and computer-readable instructions, executable code and/or software that implement exemplary embodiments of environments 100 or portions thereof as well as associated processes described herein. For example, the computing device 500 can execute the instructions, code, and/or software to provide the GUIs described herein and/or to perform the steps of the processes described herein. Exemplary storage device 524 may also store one or more databases for storing any suitable information required to implement exemplary embodiments. For example, exemplary storage device 524 can store one or more databases 526 for storing information, such as member profiles, operator profiles, non-aggregate booking requests, aggregate booking requests, aircraft information, pricing information, and/or any other suitable information/data that can be used by embodiments of the environments 100 described herein. The databases 526 may be updated manually or automatically at any suitable time to add, delete, and/or update one or more items in the databases.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the processes and/or operations described herein.

The computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the processes and/or operations described herein. In exemplary embodiments, the operating system 516 may be run in native mode or emulated mode. In an exemplary embodiment, the operating system 516 may be run on one or more cloud machine instances.

While an exemplary embodiment of the computing device 500 is described herein to include certain components, those skilled in the art will recognize that the computing device 500 may include more or fewer components. Furthermore, one skilled in the art will recognize that any computing device that can be programmed and/or configured to implement exemplary embodiments of the environment 100 or portions thereof can be utilized.

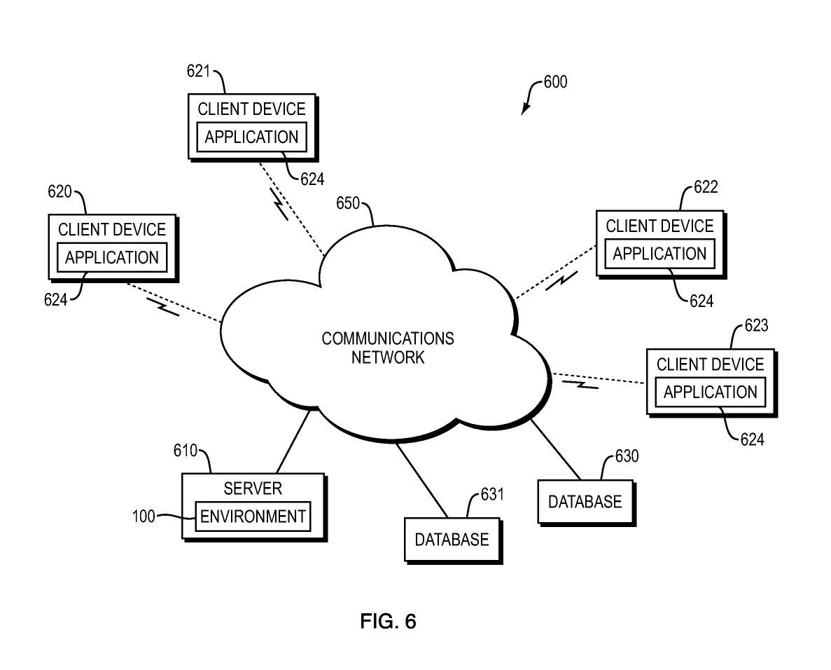

FIG. 6 is a block diagram of an exemplary client-server environment 600 configured to implement an exemplary embodiment of the environment 100. The environment 600 includes a server 610 operatively coupled to clients 620-623, via a communication network 650, which can be any network over which information can be transmitted between devices communicatively coupled to the network. For example, the communication network 650 can be the Internet, an Intranet, virtual private network (VPN), wide area network (WAN), local area network (LAN), and the like. The environment 600 can include repositories or databases 630-631, which can be operatively coupled to the server 610, as well as to clients 620-623, via the communications network 650. The server 610, clients 620-623, and databases 630-631 can be implemented as computing devices. Those skilled in the art will recognize that the database devices 630-631 can be incorporated into the server 610 such that the 610 can include databases. In an exemplary embodiment, the environment 100 can be implemented by the server 610. While the environment 100 can be executed by the server 610, those skilled in the art will recognize that the environment 100 can be distributed across multiple servers, where each server implements one or more of the components of the environment 100.

The client devices 620-623 can be operated by users of the environment 100 to facilitate interaction with the environment 100. The client devices 620-623 can each include a client side application 624 programmed and/or configured to interact with the server 610. In some embodiments, the client-side application 624 implemented by the client devices 620-623 can be a web-browser capable of navigating to one or more web pages hosting GUIs of the environment 100. In some embodiments, the client-side application 624 implemented by one or more of the client devices 620-623 can be an application specific to the environment 100 that is installed on the client devices 620-623 to permit interaction with the environment 100. As one example, the application specific to the environment 100 can be a mobile application installed and executed by a portable computing device. In exemplary embodiments, the client devices 620-623 can be configured to communicate with the network 650 via wired and/or wireless communication. In an exemplary operation, operators using the client devices 620 and 621 can access the environment 100 through operator accounts to specify operator information that can be used by the environment 100 to schedule and book chartered flights and members using client devices 622 and 623 can access the environment 100 through member accounts to search for, view, and book chartered flights as described herein.

The databases 630-631 can store information for use by the environment 100. For example, the database 630-631 can store operator profiles, member profiles, chartered flight information, shared flight information, prices for flights, passenger information for flights, and/or any other suitable information/data that can be used by embodiments of the environments 100 as described herein.

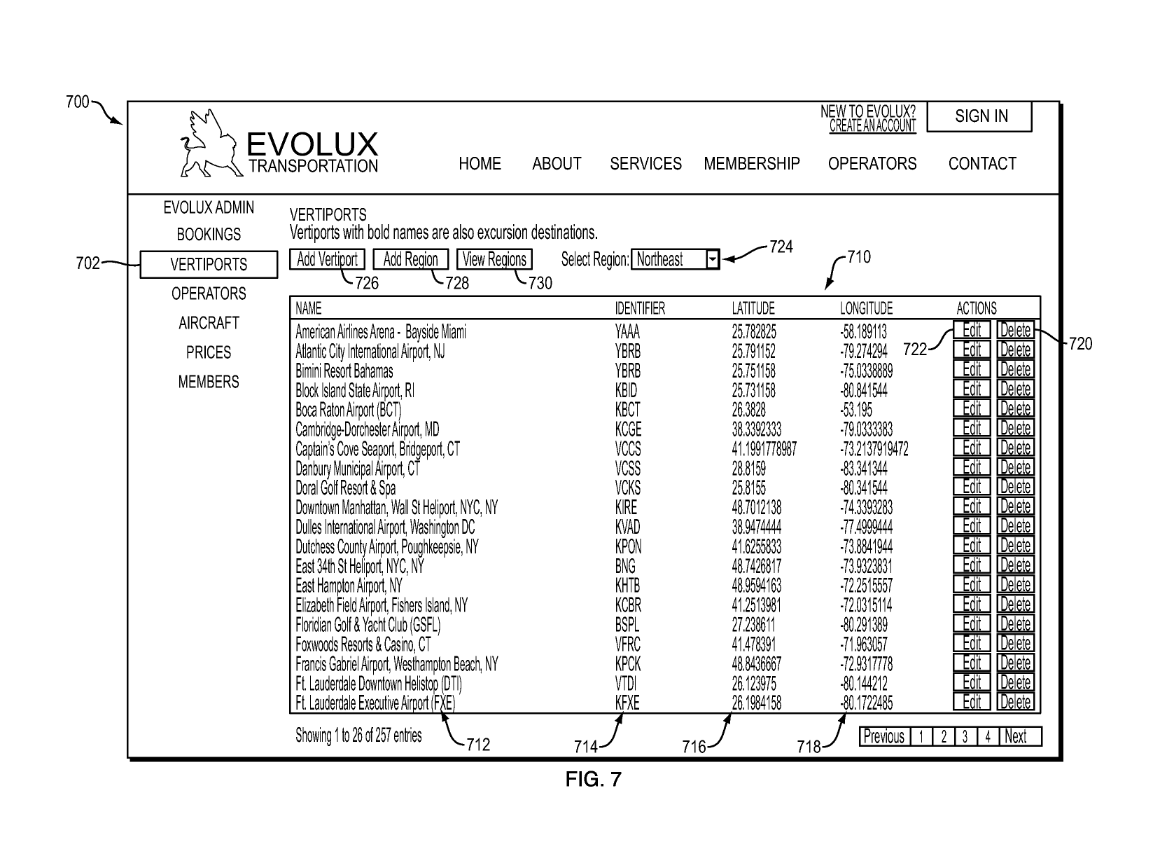

FIG. 7 is an exemplary GUI 700 that can be provided by an exemplary embodiment of the environment 100 (e.g., via the user interface 110) to facilitate an interaction between the administrators 106 and the site manager 210 of the administrator environment 120. The GUI 700 can be displayed to an administrator upon selection of a button 702 and can include a list of landing sites 710 that have been specified in the environment 100. For example, in response to the selection of the button 702, the user interface can communicate with the site manager 210 to request landing sites 710 included in the environment 100, and the site manager 210 can retrieve landing sites 710 from a database, and return the retrieved landing sites 710 to the user interface 110 to facilitate populating the GUI 700. The list can display site information including names 712 of landing sites 710, unique identifiers 714 for landing sites 710, longitudes 716 of the landing sites, a latitudes 718 of the landing sites 710. Each landing site 710 included in the list can be edited and/or deleted by an administrator. As one example, an administrator can select a button 720 associated with one of the landing sites to instruct the site manager 210 to delete the associated landing site from the environment 100. As another example, an administrator can select a button 722 associated with one of the landing sites to instruct the site manager 210 to navigate to another GUI that allows the administrator to interact with the site manager 210 to modify the site information associated with the selected landing site. In some embodiments, the GUI can include one or more filters to allow the administrator to interact with the site manager to filter the list of landing sites so that landing sites that satisfy the filtering criteria can be displayed in the list. For example, the GUI 700 can include a dropdown menu 724 that allows the administrator to filter the landing sites by a geographic region (e.g., northeast United States) within which the landing sites 710 are located.

In exemplary embodiments, the GUI 700 can include buttons 726, 728, and 730. The button 726 can be selected by an administrator to instruct the site manager 210 to navigate to another GUI that allows the administrator to interact with the site manager 210 to add a landing site location to the environment 100. The button 728 can be selected by the administrator to instruct the site manager 210 to navigate to another GUI that allows the administrator to interact with the site manager 210 to add a geographic region to the environment 100. The button 730 can be selected by the administrator to instruct the site manager 210 to navigate to another GUI that allows the administrator to interact with the site manager 210 to view geographic regions specified in the environment 100.

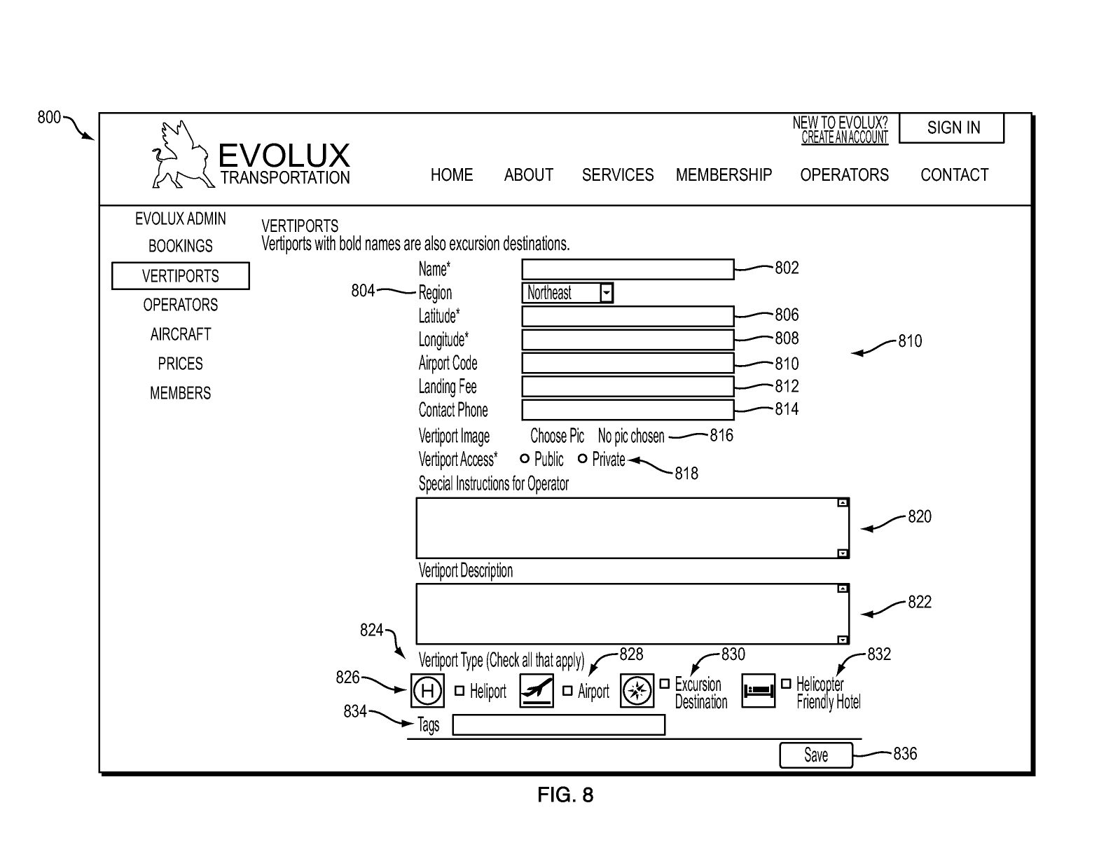

FIG. 8 is an exemplary GUI 800 that can be provided by an exemplary embodiment of the environment 100 (e.g., via the user interface 110) to facilitate adding and/or editing landing sites. For example, the GUI can be displayed in response to a selection of the buttons 722 and/or 726 in the GUI 700 shown in FIG. 7. The GUI 800 can include data entry fields 805 that allows the administrator to specify site information for a landing site. When the GUI 800 is displayed to add a landing site to the environment 100 (e.g., in response to a selection of button 726 in GUI 700), the data entry fields 805 can be empty. When the GUI is displayed to edit a landing site that is already included in the environment 100 (e.g., in response to a selection of button 722), the data entry fields can be populated with site information that was previously specified and stored in a database associated with the environment 100.

As shown in FIG. 8, the data entry fields 805 of the GUI 800 allow an administrator to specify or provide site information for a landing site that includes, for example, a name 802 for the landing site, a geographic region 804 within which the landing site is located, a latitude 806 associated with the landing site, a longitude 808 associated with the landing site, an identifier 810 (e.g., an airport code) associated with the landing site, a landing fee 812 associated with the landing site, a phone number 814 for the landing site, an image 816 of the landing site, access information 818 (e.g., public or private) for the landing site, operator instructions 820 for the landing site, a description 822 of the landing site, a type 824 of landing site (e.g., heliport, airport, excursion destination, helicopter friendly hotels), tags 834 for the landing site (e.g., metadata that can be used to retrieve the landing site from a database in response to a query), and/or any other suitable landing site information. The administrator can selection a button 836 to save and store the landing site information specified in the data entry fields 810 in the environment 100 for subsequent retrieval and/or processing.

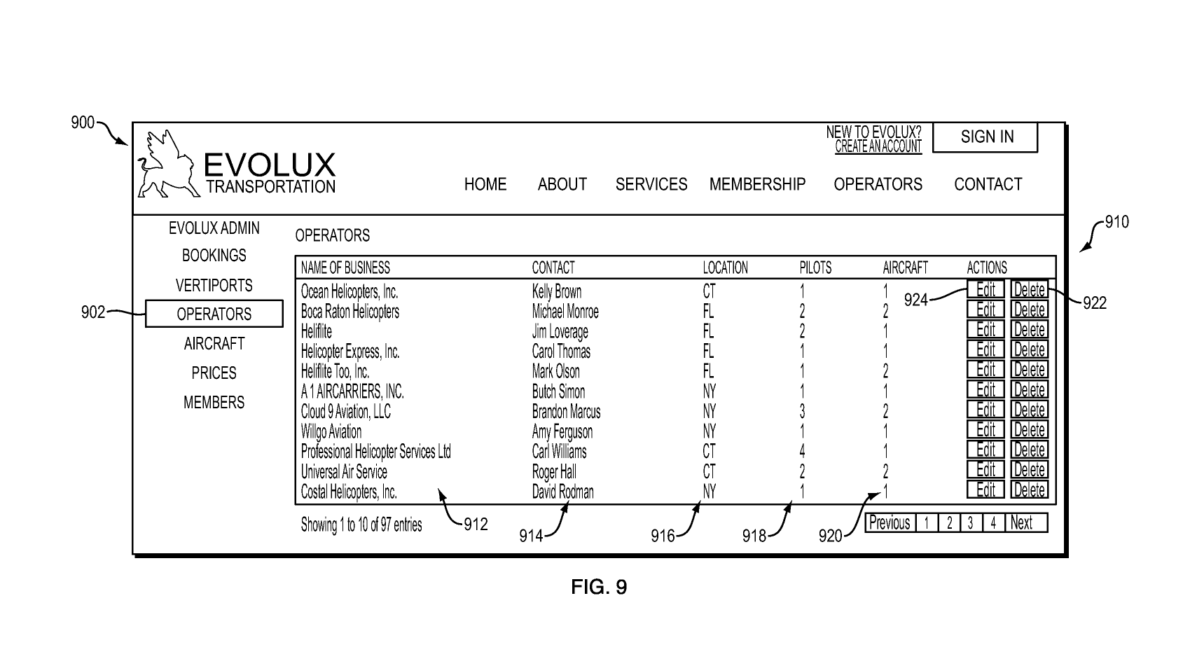

FIG. 9 is an exemplary GUI 900 that can be provided by an exemplary embodiment of the environment 100 (e.g., via the user interface 110) to facilitate an interaction between the administrators 106 and the operator manager 230 of the administrator environment 120. The GUI 900 can be displayed to an administrator upon selection of a button 902 and can include a list of operators 910 that have been specified in the environment 100. For example, in response to the selection of the button 902, the user interface 110 can communicate with the operator manager 230 to request a list of operators included in the environment 100, and the operator manager 230 can retrieve the list of operators 910 from a database, and return the retrieved the list of operators 910 to the user interface 110 to facilitate populating the GUI 900.

The list of operators 910 can display operator information including, for example, names 912 of the operators, a point of contact 914 for the operators, a geographic location 916 of the operators, a quantity of pilots 918 associated with the operators, and a quantity of aircrafts 920 operated by the operator. The operator information associated with each operator included in the list can be edited and/or deleted by an administrator. As one example, an administrator can select a button 922 associated with one of the operators to instruct the operator manager 230 to delete the operator from the environment 100. As another example, an administrator can select a button 924 associated with one of the operators to instruct the operator manager 230 to navigate to another GUI that allows the administrator to interact with the operator manager 230 to modify the operator information for the selected operator. In some embodiments, at least some of the operator information included in the list of operators 910 (e.g., a name of the operator) can be a selectable link, which upon selection, can instruct the operator manager to navigate to another GUI that allows the administrator to view a operator profile including the operator information.

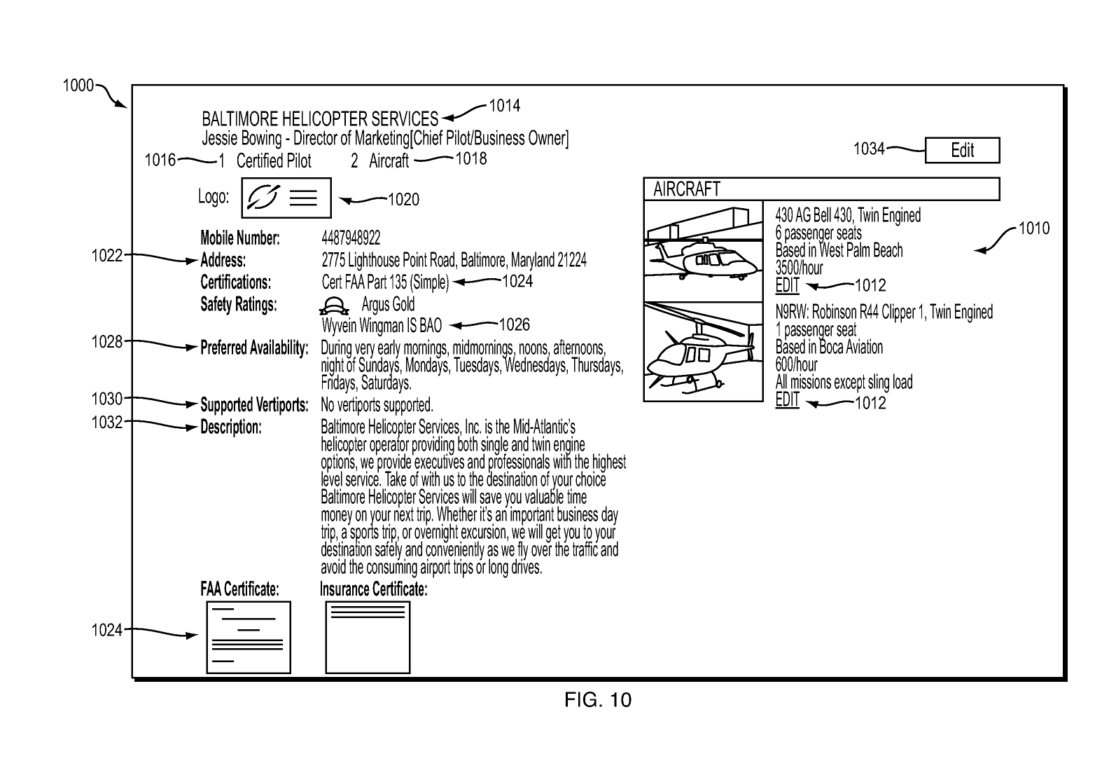

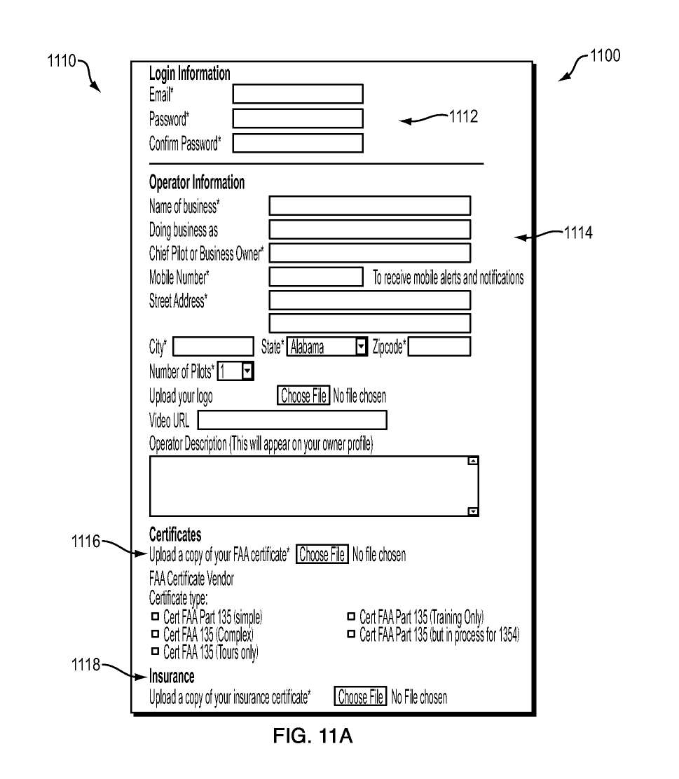

FIG. 10 is an exemplary GUI 1000 that can be provided by an exemplary embodiment of the environment 100 (e.g., via the user interface 110) to facilitate viewing of operator information included in the environment 100 (e.g., in response to a selection of a link in the GUI 900). As shown in FIG. 10, the GUI 1000 can display operator information and fleet information for an operator. The operator information can be initially specified in the environment 100 by the operator and/or by the administrator, and the operator and/or administrator can modify the operator information. The fleet information can include information 1010 about aircrafts that are operated by an operator. The information 1010 about each of the aircrafts in the operator's fleet can be edited upon selection of a link 1012 associated with each aircraft. The operator information displayed in the GUI can also include, for example, a name 1014, quantity of pilots 1016, a quantity of aircrafts 1018 in the operator's fleet, a logo 1020, contact information 1022, certifications 1024, safety ratings 1026, an availability 1028, supported landing sites 1030, and a description 1032 of the operator. In exemplary embodiments, the operator information displayed in the GUI 1010 can be edited in response to a selection of a button 1032 in the GUI 1000.

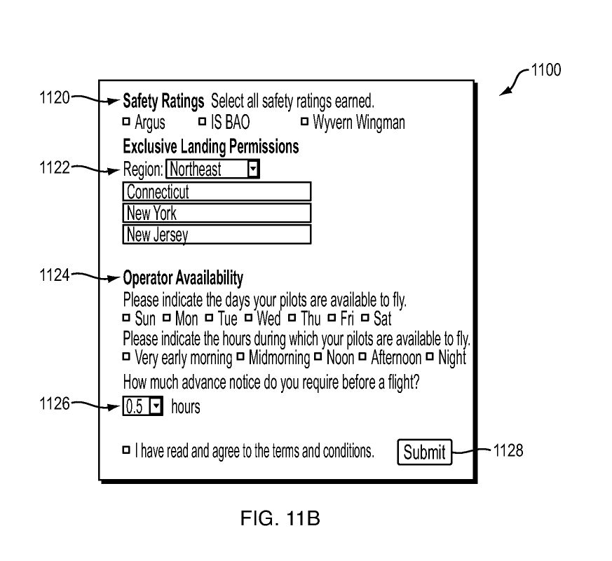

FIGS. 11A and 11B depict an exemplary GUI 1100 that can be provided by an exemplary embodiment of the environment 100 (e.g., via the user interface 110) to facilitate an interaction between the administrators 106 and the operator manager 230 of the administrator environment 120 and/or to facilitate an interaction between the operators 102 and the profile manager 320 of the operator environment 130. As shown in GUI 1100 an administrator and/or operator can specify operator information via data entry fields 1110. The data entry fields 1110 of the GUI 1100 can allow for the specification of login information 1112, operator details 1114, certificates 1116 held by the operator, insurance 1118 held by the operator, a safety rating 1120 of the operator, exclusive landing permissions 1122 for the operator, an availability 1124 of the operator, and an amount of time 1126 in advance the operator requires before booking a non-scheduled chartered flight. The login information 1112 can include a user name (e.g., an e-mail address) and a password that can be used by an operator to access the environment 100. The operator details 1114 can include a name of the operator, pilots associated with the operator, a phone number for the operator, an address of the operator, a quantity of pilots associated with the operator, a logo for the operator, and a website (e.g. specified by a Universal resource Location (URL)). The certificates 1116 can include flight certificates (e.g., FAA certificates) held by the operator. The insurance 1118 can include information about insurance held by the operator. The safety rating 1120 can allow for the specification of a safety rating associated with the operator. The exclusive landing permissions 1122 can allow for the specification of landing sites at which the operator has the exclusive right to land and/or take off. The operator availability 1124 allows for the specification of days and times that the operator is available to provide chartered transportation. The operator information specified in the data entry fields 1110 can be submitted and stored in the environment 100 upon selection of a button 1128.

In exemplary embodiments, the exclusive landing permissions 1122 can correspond to private landing sites that require permission before an operator can use the private landing sites. For example, the private landing sites can be specified in the environment 100 by the administrator (e.g., via the data entry field 818 in the GUI 800 of FIG. 8), and the exclusive landing permissions 1122 can include a list of the specified private landing sites that can be selected by the operator. When a member performs a search that specifies a private landing site as a desired departure and/or destination location, only those operators that have exclusive landing permissions at the private landing site can be returned in response to the search as being available to provided non-scheduled chartered transportation to or from the private landing site.

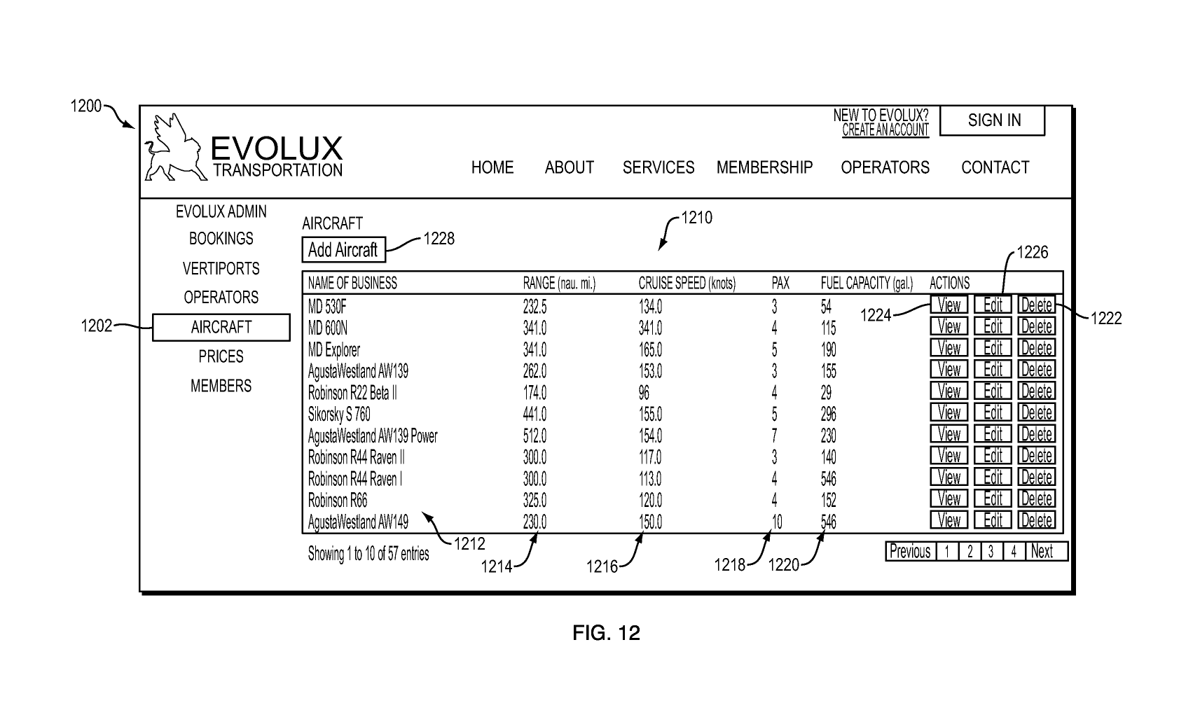

FIG. 12 is an exemplary GUI 1200 that can be provided by an exemplary embodiment of the environment 100 (e.g., via the user interface 110) to facilitate an interaction between the administrators 106 and the aircraft manager 220 of the administrator environment 120. The GUI 1200 can be displayed to an administrator upon selection of a button 1202 and can include a list of landing sites 1210 that have been specified in the environment 100. For example, in response to the selection of the button 1202, the user interface can communicate with the aircraft manager 220 to request aircrafts 1210 included in the environment 100, and the aircraft manager 220 can retrieve aircrafts 1210 from a database, and return the retrieved aircrafts 1210 to the user interface 110 to facilitate populating the GUI 1200. The list can display aircraft information including names or models 1212 of aircrafts 1210, flight ranges 1214 for the aircrafts, cruise speeds 1216 for the aircrafts, quantities of passengers 1218 accommodated by the aircrafts, and fuel capacities 1220 of the aircrafts.

Each aircraft 1210 included in the list can be viewed, edited and/or deleted by an administrator. As one example, an administrator can select a button 1222 associated with one of the aircrafts to instruct the aircraft manager 220 to delete the associated aircrafts from the environment 100. As another example, an administrator can select a button 1224 associated with one of the aircrafts to navigate to another GUI that allows the administrator to interact with the aircraft manager 220 to view additional aircraft information associated with the selected aircraft. As yet another example, an administrator can select a button 1226 associated with one of the aircrafts to instruct the aircraft manager 220 to navigate to another GUI that allows the administrator to interact with the aircraft manager 220 to modify the aircraft information associated with the selected aircraft. In exemplary embodiments, the GUI can include a buttons 1228 that can be selected by an administrator to instruct the aircraft manager 220 to navigate to another GUI that allows the administrator to interact with the aircraft manager 220 to add an aircraft to the environment 100.

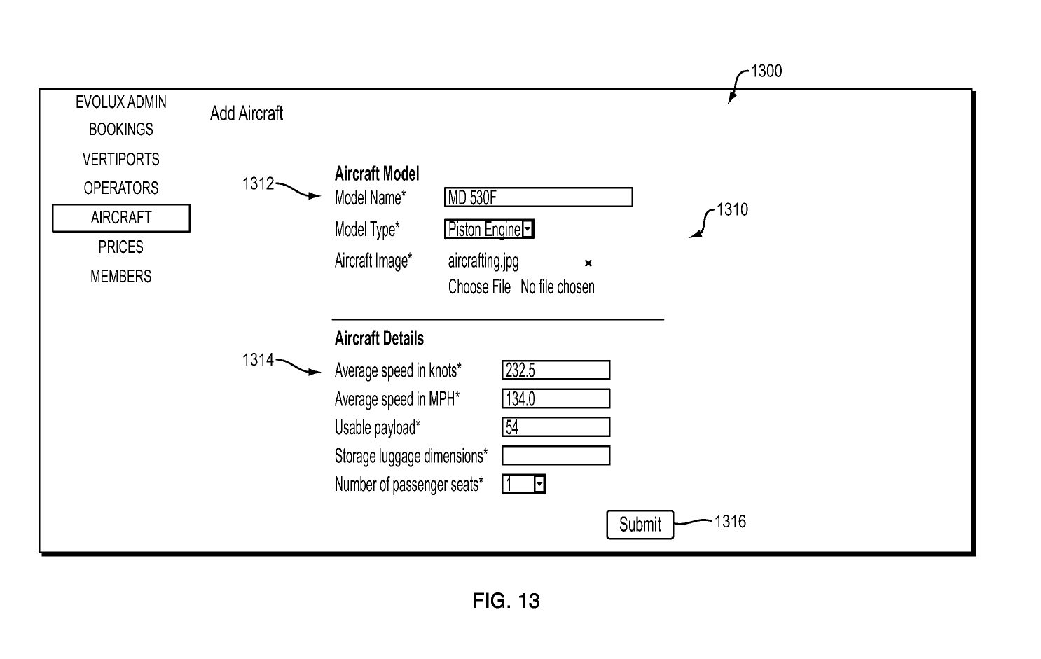

FIG. 13 is an exemplary GUI 1300 that can be provided by an exemplary embodiment of the environment 100 (e.g., via the user interface 110) to facilitate adding and/or editing aircrafts. For example, the GUI 1300 can be displayed in response to a selection of the buttons 1226 and/or 1228 in the GUI 1200 shown in FIG. 12. The GUI 1300 can include data entry fields 1305 that allow the administrator to specify aircraft information for an aircraft. When the GUI 1300 is displayed to add an aircraft to the environment 100 (e.g., in response to a selection of button 1228 in GUI 1200), the data entry fields 1305 can be empty. When the GUI 1300 is displayed to edit information about an aircraft that is already included in the environment 100 (e.g., in response to a selection of button 1226), the data entry fields can be populated with aircraft information that was previously specified and stored in a database associated with the environment 100.

As shown in FIG. 13, the data entry fields 1305 of the GUI 1300 allow an administrator to specify or provide aircraft information for an aircraft that includes, for example, aircraft model information 1312 and aircraft details 1314. The aircraft model information 1312 can include a model name of the aircraft, a model type of the aircraft, and an image of the aircraft. The aircraft details can include average cruising speed for the aircraft (e.g., in knots and/or miles per hour), a usable payload of the aircraft, storage dimensions (e.g., for luggage) of the aircraft, and a number of passenger seats. The administrator can select a button 1316 to save and store the aircraft information specified in the data entry fields 1210 in the environment 100 for subsequent retrieval and/or processing.

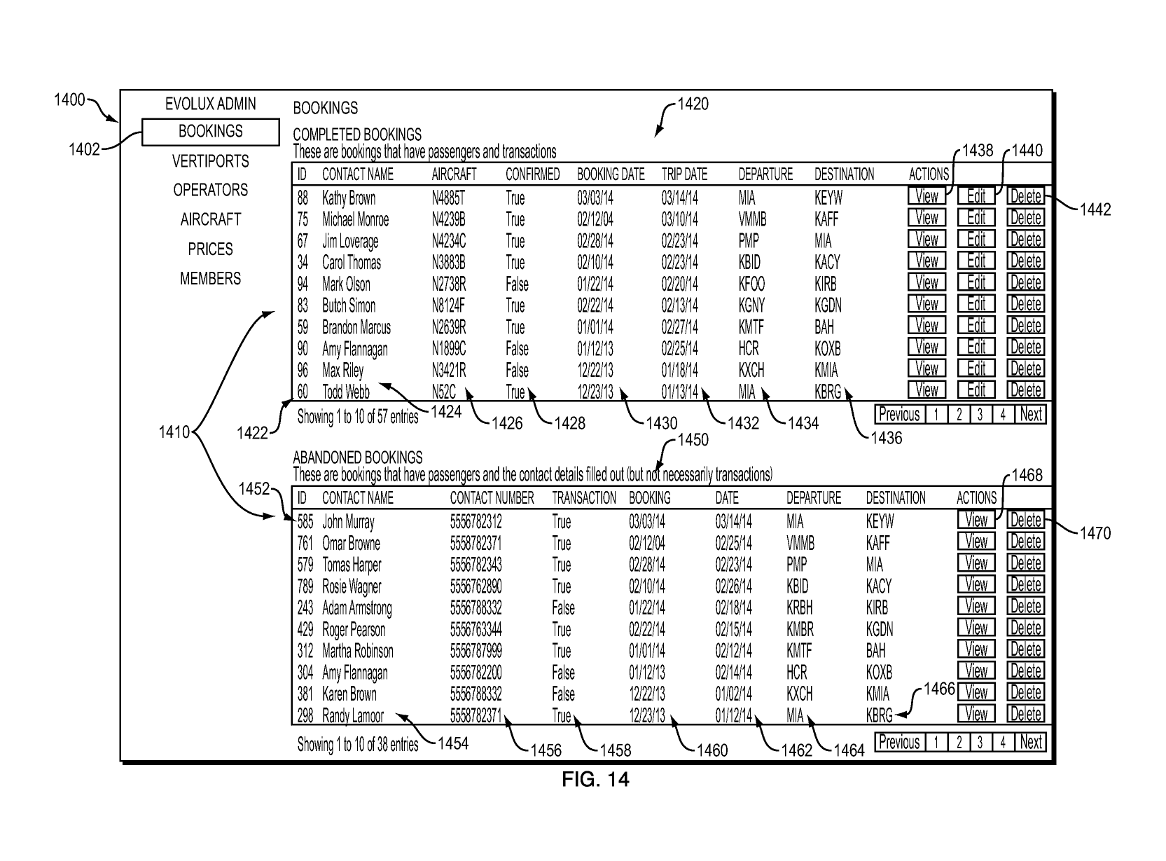

FIG. 14 is an exemplary GUI 1400 that can be provided by an exemplary embodiment of the environment 100 (e.g., via the user interface 110) to facilitate an interaction between the administrators 106 and the booking manager 240 of the administrator environment 120. The GUI 1400 can be displayed to an administrator upon selection of a button 1402 and can display bookings 1410 that are generated via the booking engine 242 of the booking manager 240. For example, in response to the selection of the button 1402, the user interface 110 can communicate with the booking manager 240 to request the bookings 1410 included in the environment 100, and the booking manager 240 can retrieve the bookings 1410 from a database, and return the retrieved bookings 1410 to the user interface 110 to facilitate populating the GUI 1400. In the present embodiment, the bookings 1410 can be displayed in lists 1420 and 1450. The list 1420 can include completed bookings (e.g., bookings confirmed by the operator and the passengers), and the list 1450 can include abandoned bookings (e.g., booking requests that denied by the operator and/or booking requests that were denied by the operator and for which the member did not initiate another booking request).

The list 1420 can display booking information including booking identifiers 1422, passenger names 1424, an aircraft 1426 to be used, a confirmation status 1428, a booking date 1430, a trip date 1432, a departure location 1434, and a destination location 1436. Each booking 1410 included in the list 1420 can be viewed, edited and/or deleted by an administrator. As one example, an administrator can select a button 1438 associated with one of the bookings in the list 1420 to instruct the booking manager 240 to navigate to another GUI that allows the administrator to interact with the booking manager 240 to view the booking information associated with the selected booking. As another example, an administrator can select a button 1440 associated with one of the bookings in the list 1420 to instruct the booking manager 240 to delete the booking from the environment 100. As yet another example, an administrator can select a button 1442 associated with one of the bookings in the list 1420 to instruct the booking manager 240 to navigate to another GUI that allows the administrator to interact with the booking manager 240 to modify the booking information associated with the selected booking.

The list 1450 can display booking information including booking identifiers 1452, passenger names 1454, a phone number 1456 for the passengers or operators, a transaction status 1458, a booking date 1460, a trip date 1462, a departure location 1464, and a destination location 1466. Each booking 1410 included in the list 1450 can be viewed and/or deleted by an administrator. As one example, an administrator can select a button 1468 associated with one of the bookings in the list 1450 to instruct the booking manager 240 to navigate to another GUI that allows the administrator to interact with the booking manager 240 to view the booking information associated with the selected booking. As another example, an administrator can select a button 1470 associated with one of the bookings in the list 1450 to instruct the booking manager 240 to delete the booking from the environment 100.

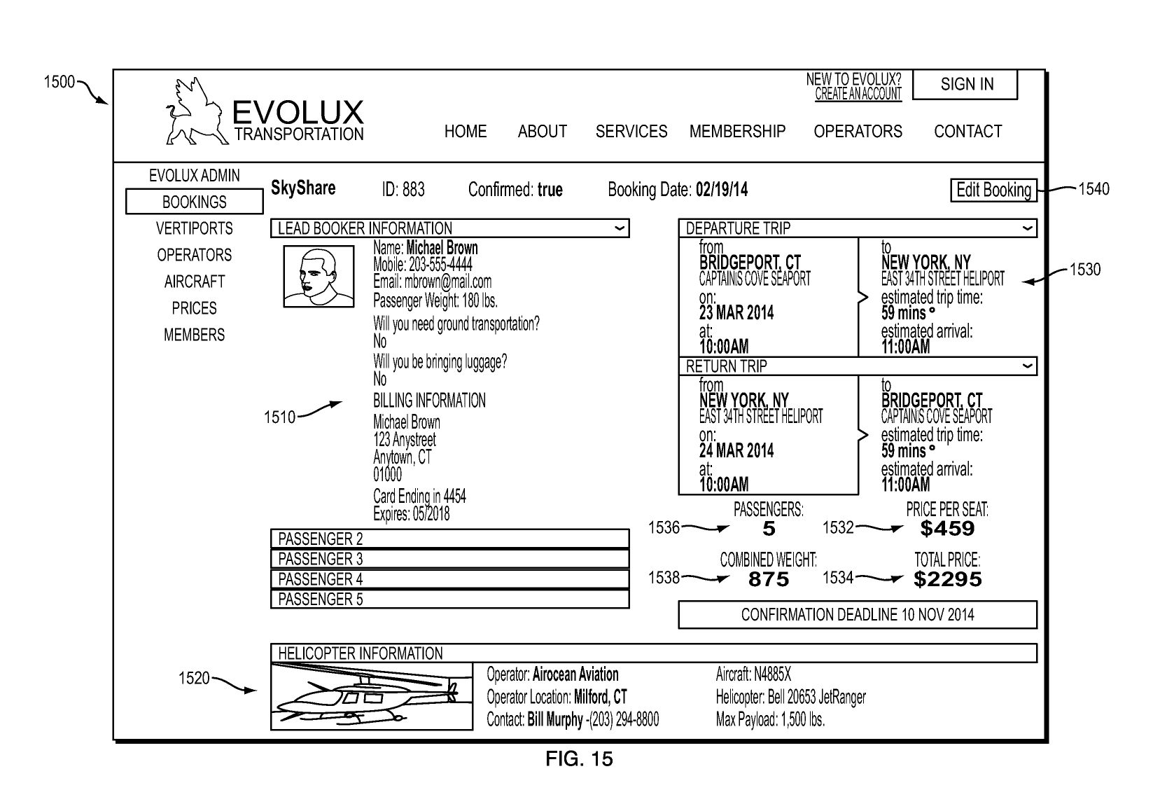

FIG. 15 is an exemplary GUI 1500 that can be provided by an exemplary embodiment of the environment 100 (e.g., via the user interface 110) to facilitate viewing of booking information included in the environment 100 for a booking associated with an aggregate booking request (or a shared transportation request) for non-scheduled chartered transportation (e.g., in response to a selection of buttons 1438 and/or 1468 in the GUI 1400 associated with a shared booking). As shown in FIG. 15, the GUI 1500 can display passenger information 1510, operator information 1520, and trip information 1530. The passenger information 1510 can include member information for each member that joined the non-scheduled chartered flight. The operator information 1520 can include operator information for the operator that is providing the non-scheduled chartered flight and can identify aircraft information associated with the chartered aircraft. The trip information 1530 can include information related to each leg of a trip (e.g., one-way trips, round trips, and/or multi-stop trips) and can provide departure locations, departure times, destination locations, and estimated flight times. The trip information 1530 can also include information related to a price 1532 for chartering the aircraft for the trip on a per seat basis (e.g., because the passengers are sharing the chartered aircraft) as well as a total price 1534 corresponding to the total cumulative cost of the trip, and can also include a number of passengers 1536 and a combined weight 1538 of the passengers (e.g., including any luggage brought by the passengers). An administrator can select a button 1540 to instruct the booking manager 240 to navigate to another GUI that allows the administrator to interact with the booking manager 240 to modify the booking information associated with the selected booking.

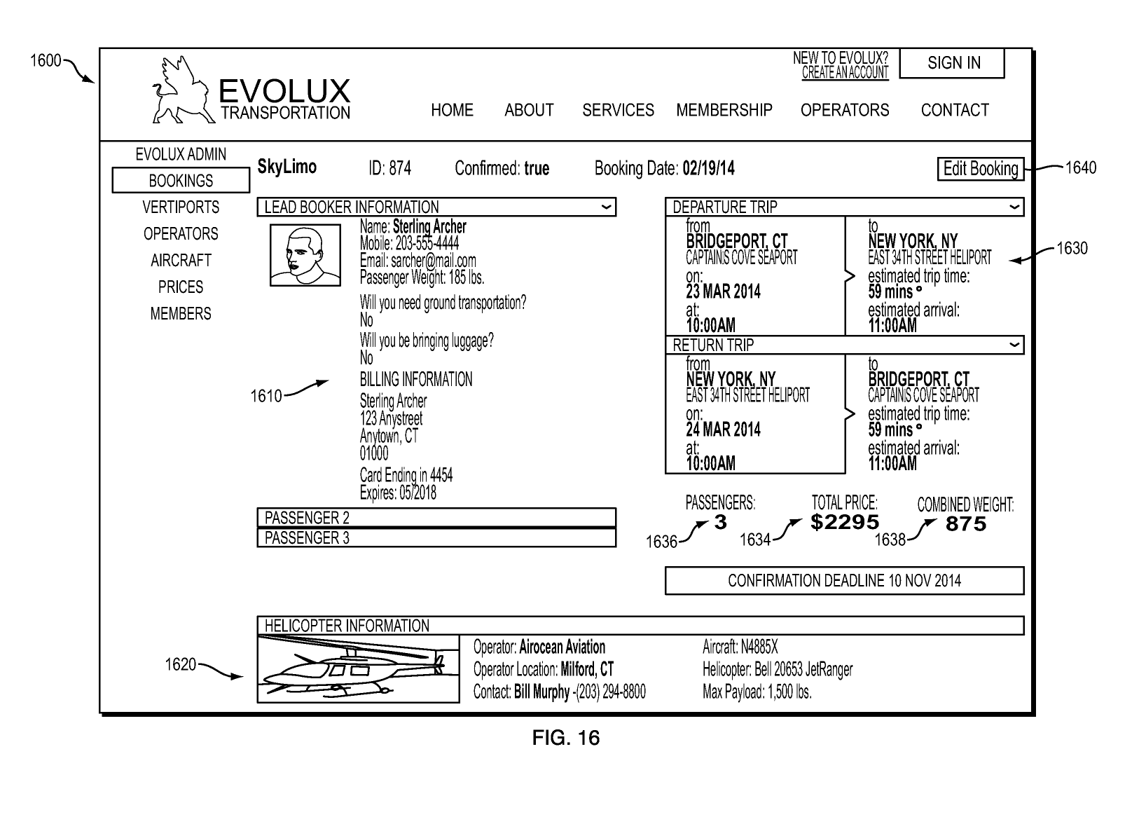

FIG. 16 is an exemplary GUI 1600 that can be provided by an exemplary embodiment of the environment 100 (e.g., via the user interface 110) to facilitate viewing of booking information included in the environment 100 for a booking associated with a non-aggregated booking request of an entire aircraft by a member of the environment 100 (e.g., in response to a selection of buttons 1438 and/or 1468 in the GUI 1400 associated with a non-aggregated booking request). As shown in FIG. 16, the GUI 1600 can display passenger information 1610, operator information 1620, and trip information 1630. The passenger information 1610 can include member information for the member that booked the non-scheduled chartered aircraft and can include passenger information specified by the member. The operator information 1620 can include operator information for the operator that is providing the non-scheduled chartered flight and can identify aircraft information associated with the chartered aircraft. The trip information 1630 can include information related to each leg of a trip (e.g., one-way trips, round trips, and/or multi-stop trips) and can provide departure locations, departure times, destination locations, and estimated flight times. The trip information 1630 can also include information related to a total price 1634 corresponding to the total cumulative cost of the trip, and can also include a number of passengers 1636 and a combined weight 1638 of the passengers (e.g., including any luggage brought by the passengers). An administrator can select a button 1640 to instruct the booking manager 240 to navigate to another GUI that allows the administrator to interact with the booking manager 240 to modify the booking information associated with the selected booking.

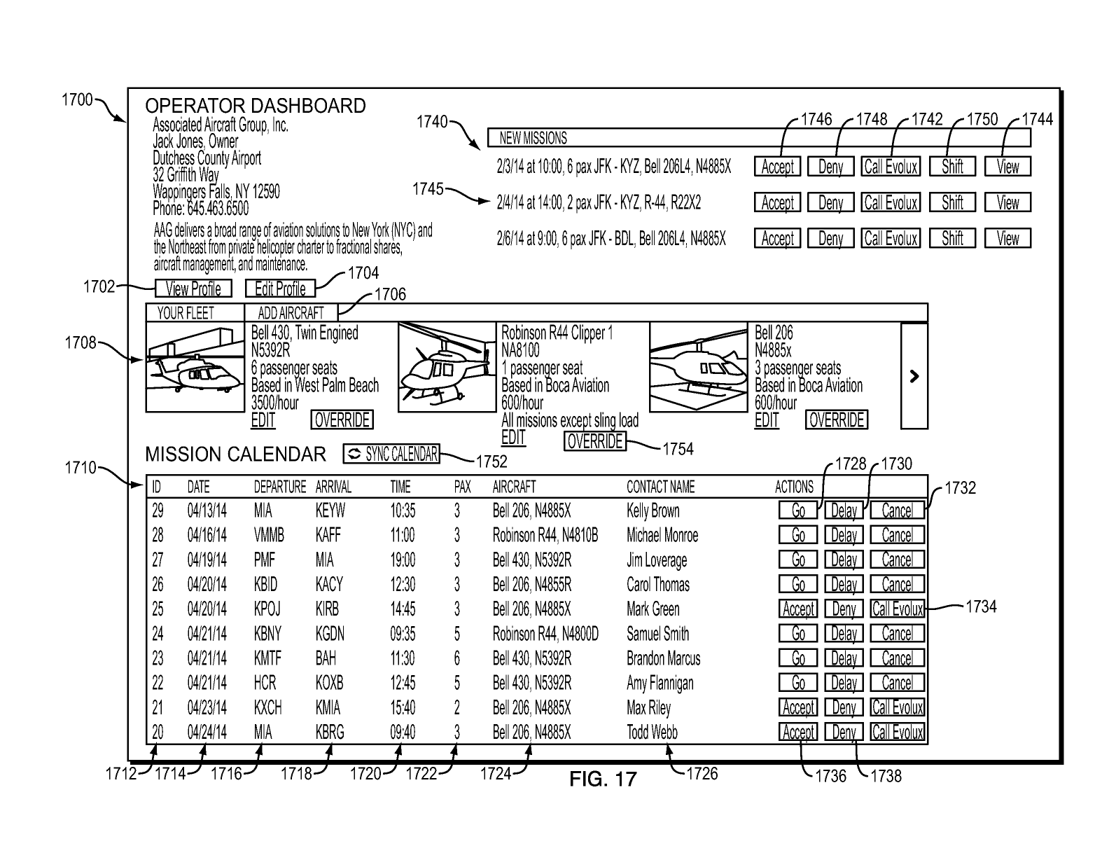

FIG. 17 is an exemplary GUI 1700 that can be provided by an exemplary embodiment of the environment 100 (e.g., via the user interface 110) to facilitate an interaction between the operators 102 and the operator dashboard engine 310 of the operator environment 130. In exemplary embodiments, the GUI 1700 can be displayed when an operator logs into the environment 100 and allows the operator to manage its presence in the environment 100. For example, an operator can select a button 1702 in the GUI 1700 to instruct the dashboard engine 310 to navigate to another GUI that allows the operator to interact with the profile manager 320 to view the operator profile 322 associated with the operator. An exemplary embodiment of the GUI 1000 of FIG. 10 can be displayed to an operator to allow the operator to view the operator's profile (e.g., in response to a selection of the button 1702). To edit the operator profile, the operator can select a button 1704 in the GUI to instruct the dashboard engine 310 to navigate to another GUI that allows the operator to interact with the profile manager 320 to view the operator profile 322 associated with the operator. An exemplary embodiment of the GUI 1100 of FIGS. 11A-B can be displayed to an operator to allow the operator to edit the operator's profile (e.g., in response to a selection of the button 1704). In instances when a new operator wishes to access the environment 100, the operator can be directed to an exemplary embodiment of the GUI 1100 to allow the operator to specify the operator information and generate an operator account. The GUI 1700 can provide a fleet area 1708 that displays aircraft information regarding aircraft that the operator has added to the environment 100 and includes an “Add Aircraft” button 1706. The operator can select the button 1706 to instruct the dashboard engine 310 to navigate to another GUI that allows the operator to interact with the fleet manager 330 to manage the operator's fleet information.

As shown in FIG. 17, the GUI 1700 can include a (mission) calendar 1710 that includes booking requests 1715 (e.g., non-aggregate and aggregate booking requests) that have been presented to the operator. For each booking request in the calendar, the dashboard engine 310 can communicate with the user interface 110 to populate the GUI 1700 with booking information, such as, a booking identifier 1712, a trip date 1714, a departure location 1716, a destination location 1718, a departure time 1720, a number of passengers 1722, an aircraft 1724 that will be used, and passenger contact information 1726. Each booking request 1715 displayed in the calendar 1710 can have one or more buttons 1728, 1730, 1732, and 1734 to allow the operator to implement one or more actions with respect, such as a specify whether the chartered flight is a go or a no-go, indicate that the flight is delayed, indicate that the flight is canceled, indicate that the requested booking is accepted, initiate a call with the provider of the environment, and/or to implement any other suitable actions for the requested bookings.

In the present embodiment, at least one of the booking requests 1715 can be associated with a button 1728, which can be selected by an operator to indicate that the chartered flight for a previously accepted booking request is a go (e.g., that the chartered flight is set to depart at the requested time). At least one of the booking requests 1715 can be associated with a button 1730, which can be selected by an operator to indicate that the chartered flight associated with an accepted booking request has been delayed (e.g., because of weather or mechanical issues). At least one of the booking requests 1715 can be associated with a button 1732, which can be selected by an operator to indicate that the chartered flight associated with an accepted booking request has been canceled (e.g., because of weather or mechanical issues). At least one of the booking requests 1715 can be associated with a button 1734, which can be selected by an operator to initiate communication with the provider of the environment 100. At least one of the booking requests 1715 can be associated with a button 1736, which can be selected by an operator to indicate that the chartered flight associated with the booking request has been accepted. In response to accepting the booking request, the dashboard engine 310 can be programmed and/or configured to instruct the booking manager 240 in the administrator environment 120 to update the bookings to reflect the acceptance from the operator. The booking manager 240 can programmed to provide a notification to the member (or members) that requested the booking that the booking has accepted the request and that their reservation for a non-scheduled chartered flight has been confirmed.

The button 1738 associated with one of the booking requests 1715 can be selected by the operator to deny the selected booking request 1715. In response to denying the booking request, the dashboard engine 310 can be programmed and/or configured to instruct the booking manager 240 in the administrator environment 120 to update the bookings to reflect the rejection from the operator. The booking manager 240 can programmed to provide an notification to the member (or members) that requested the booking, that the booking request has been denied. In exemplary embodiments, the booking manager 240 can implement an exception procedure when an operator denies a requested booking when the operator information indicates that the operator should be available to provide chartered transportation. For example, the booking manager 240 can send a notification to the administrator requesting that the administrator contact the operator to resolve the issue. In the event that the operator denies a booking request, the booking manager can be programmed and/or configured to communicate with the search engine 420 of the member environment 140 to identify alternative chartered aircraft that can be booked for (or near) the date and time of the requested booking as well as for (or near) the departure and/or destination locations. In exemplary embodiments, the buttons associated with the requested booking requests 1715 in the calendar 1710 can change based on previous actions taken by the operator, a current status of the requested booking, and/or based on any other suitable information.

In exemplary embodiments, the GUI 1700 can provide a new missions area 1740 to highlight new booking requests 1745 that have been received by the operator (e.g., within a specified time period, since the last time the operator logged into the environment 100, requests that have not been accepted or denied yet, etc.). The area 1740 can display a brief description of the booking requests 1745 and can associated buttons 1742, 1744, 1746, 1748, and 1750 with each of the booking requests 1745. The button 1742 can be selected by an operator to initiate communication with the provider of the environment 100. The button 1744 can be selected by an operator to instruct the dashboard engine 310 to navigate to another GUI (e.g., GUI 1000 of FIG. 10)) to view booking information (e.g., based on an execution of the booking manager 240). The button 1746 associated with one of the booking request 1745 can be selected by the operator to accept the booking request 1745. In response to accepting the booking request, the dashboard engine 310 can be programmed and/or configured to instruct the booking manager 240 in the administrator environment 120 to update the bookings to reflect the acceptance from the operator. The booking manager 240 can programmed to provide a notification to the member (or members) that requested the booking that the booking request has been accepted and that their reservation for a non-scheduled chartered flight has been confirmed.

The button 1748 associated with a booking request can be selected by the operator to deny the booking request. In response to denying the booking request, the dashboard engine 310 can be programmed and/or configured to instruct the booking manager 240 in the administrator environment 120 to update the booking requests to reflect the rejection from the operator. The booking manager 240 can programmed to provide an notification to the member (or members) that requested the booking that the booking has denied. In exemplary embodiments, the booking manager 240 can implement an exception procedure when an operator denies a requested booking when the operator information indicates that the operator should be available to provide chartered transportation. For example, the booking manager 240 can send a notification to the administrator requesting that the administrator contact the operator to resolve the issue. In the event that the operator denies a booking request, the booking manager can be programmed and/or configured to communicate with the search engine 420 of the member environment 140 to identify alternative chartered aircraft that can be booked for (or near) the date and time of the booking requested as well as for (or near) the departure and/or destination locations.

The button 1750 can be selected by the operator generate a response to a booking request that requests that the departure date and/or time included in the booking request be shifted. In response to the selection of the button 1750, the dashboard engine 310 can be programmed and/or configured to receive a new date and/or time from the operator and to instruct the booking manager 240 in the administrator environment 120 to generate a response to the member (or members) that submitted the booking requests indicating that the shifted date and/or time provided by the operator. The member (or members) can respond to the shift in the date and/or time by accepting and/or rejecting the shift. If the member (or members) accept the shift, the booking request can again be presented to the operator for acceptance or denial or can be automatically accepted. If the member (or members) reject the shift in the date and/or time, the booking manager 240 can programmed and/or configured to communicate with the search engine 420 of the member environment 140 to identify alternative chartered aircraft that can be booked for (or near) the date and time of the booking requested as well as for (or near) the departure and/or destination locations.

In exemplary embodiments, the dashboard engine 310 can be programmed and/or configured to synchronize the calendar 1710 displayed in the GUI 1700 with an external calendar used by the operator to schedule chartered flights externally to the environment 100. The synchronization of the calendar 1710 with the external calendar can cause the dashboard engine to incorporate the information in the operator's external calendar into the calendar 1710. By synchronizing the calendars, the environment 100 can obtain additional information regarding the operations of the operator, which can be utilized by the environment 100 to improve utilization of the operator's service and/or to provide improved service to the members. For example, in exemplary embodiments, when an operator synchronizes the calendar 1710 with the operator's external calendar, the dashboard engine 310 can determine additional availability of the operator's aircraft as well as additional departure locations from which the aircraft can depart.

One situation where this can be useful, for example, is when the an aircraft operated by the operator is scheduled for chartered transportation external to the environment to transport passengers from a departure location to a destination location, but has no passengers for the flight back to the home location of the aircraft. If the calendars are synchronized, the dashboard engine 310 can be programmed to update and/or alter (e.g., override) the location information for the aircraft and the availability of the aircraft to reflect the scheduled day and time that the aircraft will be at the out-of-position location (e.g., the aircraft is away from its default home location) so that results to searches performed by members that correspond, for example to a departure location that is near the out-of-position location of the aircraft, a departure time that is near the time at which the aircraft is located at the out of position location, and to destination location that is near the home location of the aircraft can include aircraft; thereby providing the operator an opportunity to book a flight that the operator would have otherwise flown without any passengers and providing members with an additional transportation option that would otherwise not have been provided to the members if the environment 100 did not include the information in the operator's external calendar.

In exemplary embodiments, the fleet area 1708 can include a button 1754 associated with each aircraft. The button can selected by the operator to override a specified home location and/or availability of an aircraft in the operator's fleet. For example, if the aircraft is (or is going to be) at a location other than the home location (e.g., an out-of-position location), the operator can temporarily override the specified home location such that the home location of the aircraft is set to the out-of-position location. Likewise, if an aircraft is specified as being unavailable at a given time, the operator can temporarily override the specified availability of the aircraft so that the aircraft is shown as available. In some embodiments, the temporary location and availability can be persistent such that the operator must reset the location and availability information to its permanent values. In some embodiments, the operator can specify a date and/or time range over which the location and availability information remains overridden and upon expiration of the range, the location and availability of the aircraft can automatically be returned to its permanent values.

In the event that the operator overrides the home location and/or availability of the aircraft, the temporary location and availability information can be stored in a database that is queried in response to searches performed by the members. Results to searches performed by members that correspond, for example to a departure location that is near the out-of-position location of the aircraft specified by the override and a departure time that is near the time at which the aircraft is located at the out of position location specified by the override can include the aircraft; thereby providing the operator an opportunity to book a flight for which the operator would not have otherwise been considered and providing members with an additional transportation options that would otherwise not have been provided to the members if the environment 100 did not permit for overriding the home location and/or the availability of the aircraft. In some embodiments, the aircraft can be equipped with GPS and can transmit location information to the environment 100. The environment 100 can be programmed and/or configured to utilize the location information to automatically update the location of the aircraft.

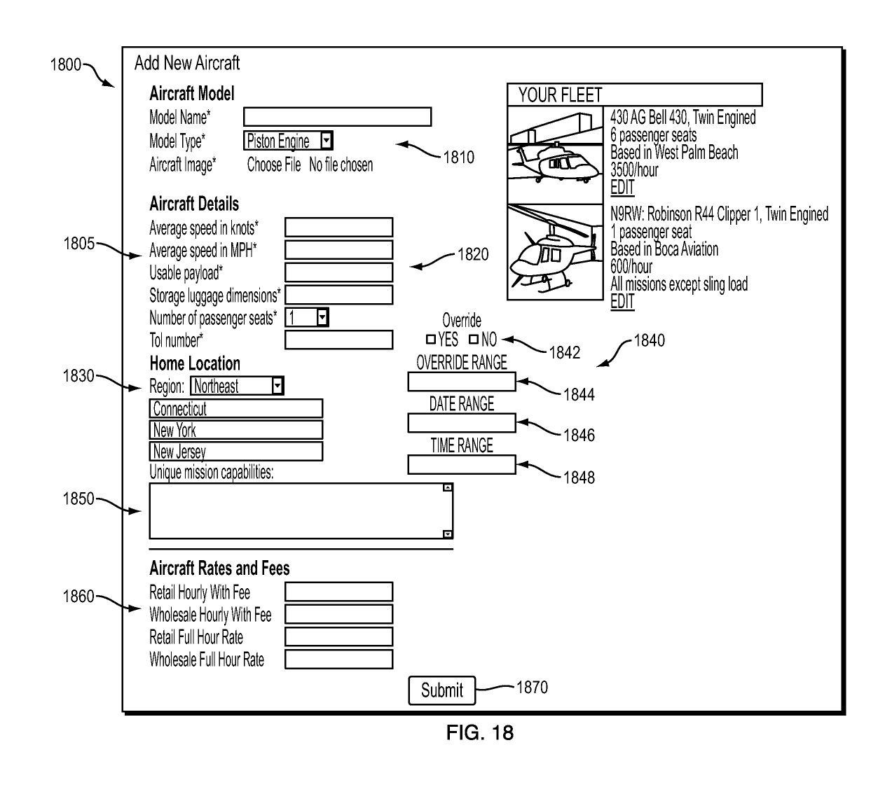

FIG. 18 is an exemplary GUI 1800 that can be provided by an exemplary embodiment of the environment 100 (e.g., via the user interface 110) to facilitate adding and/or editing of aircrafts to an operator's fleet (e.g., in response to a selection of the buttons 1705 and/or 1706 in the GUI 1700). The GUI 1800 can include data entry fields 1805 that allows the operator to specify aircraft information for an aircraft that forms a part of the operator's fleet. When the GUI 1800 is displayed to add an aircraft to the operator's fleet (e.g., in response to a selection of button 1706 in GUI 1700), the data entry fields 1805 can be empty. When the GUI 1800 is displayed to edit information about an aircraft that is already included in the operator's fleet (e.g., in response to a selection of button 1705), the data entry fields can be populated with aircraft information that was previously specified and stored in a database associated with the environment 100.

As shown in FIG. 18, the data entry fields 1805 of the GUI 1800 allow an operator to specify or provide aircraft information for an aircraft that includes, for example, aircraft model information 1810, aircraft details 1820, home location information 1830, override location information 1840, aircraft capabilities 1850, and rate and fee information for chartering the aircraft. The aircraft model information 1310 can include a model name of the aircraft, a model type of the aircraft, and an image of the aircraft. The aircraft details 1820 can include average cruising speed for the aircraft (e.g., in knots and/or miles per hour), a usable payload of the aircraft, storage dimensions (e.g., for luggage) of the aircraft, and a number of passenger seats. The home location information 1830 can include one or more home locations for the aircraft. For example, in some embodiments, the aircraft can have different home locations depending on the day and time. The operator can interact with the GUI to specify a home location of each different home location of the aircraft based on the day and time that the aircraft will be located at the home location. The override location 1840 can be specified by the operator to override the home location information 1830 and can include an override selector 1842, an override location field 1844, and date and time range fields 1846 and 1848, respectively. The override selector 1842 can initiate a home location override. The override location field 1844 can be configured to receive an override location for the aircraft. The date and time range fields 1846 and 1848 can be configured to receive a date range and a time range, respective, for which the home location override is active and valid. The rate and fee information 1860 can include a retail hourly wait fee, a wholesale hourly wait fee, a retail full hour rate, a wholesale full hour rate. The operator can select a button 1870 to save and store the aircraft information specified in the data entry fields 1805 in the environment 100 to include the aircraft in the operator's fleet.

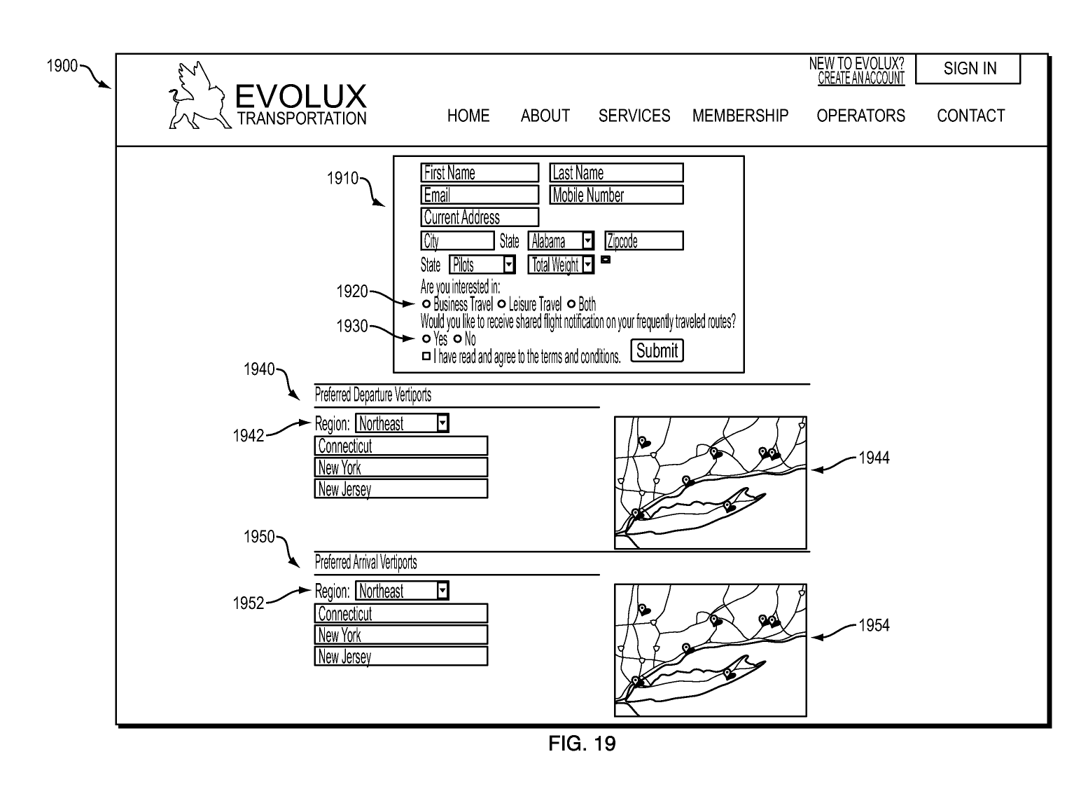

FIG. 19 depicts an exemplary GUI 1900 that can be provided by an exemplary embodiment of the environment 100 (e.g., via the user interface 110) to facilitate an interaction between the members 104 and the member manager 410 of the member environment 140. The GUI 1900 can allow a member to create and/or edit a member profile. As shown in GUI 1900, a member can specify member information via data entry fields 1910. The data entry fields 1910 of the GUI 1900 can allow for the specification of, for example, a name of the member, contact information for the member, and physical attributes of the member (e.g., height and weight). In some embodiments, the data entry fields can be provided to allow the member to specify a username and password that can be used to access the environment 100. Other member information that can be specified via the GUI 1900 includes a type 1920 of travel in which the member is interested (e.g., business, leisure, both, etc.) and an indication 1930 as to whether the member would like to receive shared flight notifications for non-scheduled chartered flights created and shared by other members of the environment 100.

In exemplary embodiments, the GUI 1900 can allow the member to specify one or more preferred departure locations 1940 to be associated with the member's profile. The member can use a filter 1942 to limit the departure locations, from which the user can select, to geographic regions. A map 1944 can be generated include markers which over lay the map to show the geographic location of the departure locations on the map 1944. Likewise, the GUI 1900 can allow the member to specify one or more preferred destination locations 1950. The member can use a filter 1952 to limit the destination locations, from which the user can select, to geographic regions. A map 1954 can be generated include markers which over lay the map to show the geographic location of the destination locations on the map 1954.

The information received via the GUI 1900 can be associated with the member's account and can be used by one or more of the components of the environment 100 to perform one or more processes. As one example, in some embodiments, the height and weight information can be used by the price calculation engines 252 of the price manager 250 to determine prices for non-scheduled chartered flights. As another example, in some embodiments, the preferred departure and destination location information can be used by the search engine 420 and/or the shared transportation engine 430 to programmatically search one or more databases for aggregate booking requests that include the preferred departure locations (or locations near the preferred departure locations, e.g., with a predetermined number of miles of the preferred departure locations) and/or preferred destination locations (or locations near the preferred destination locations, e.g., with a predetermined number of miles of the preferred destination locations).

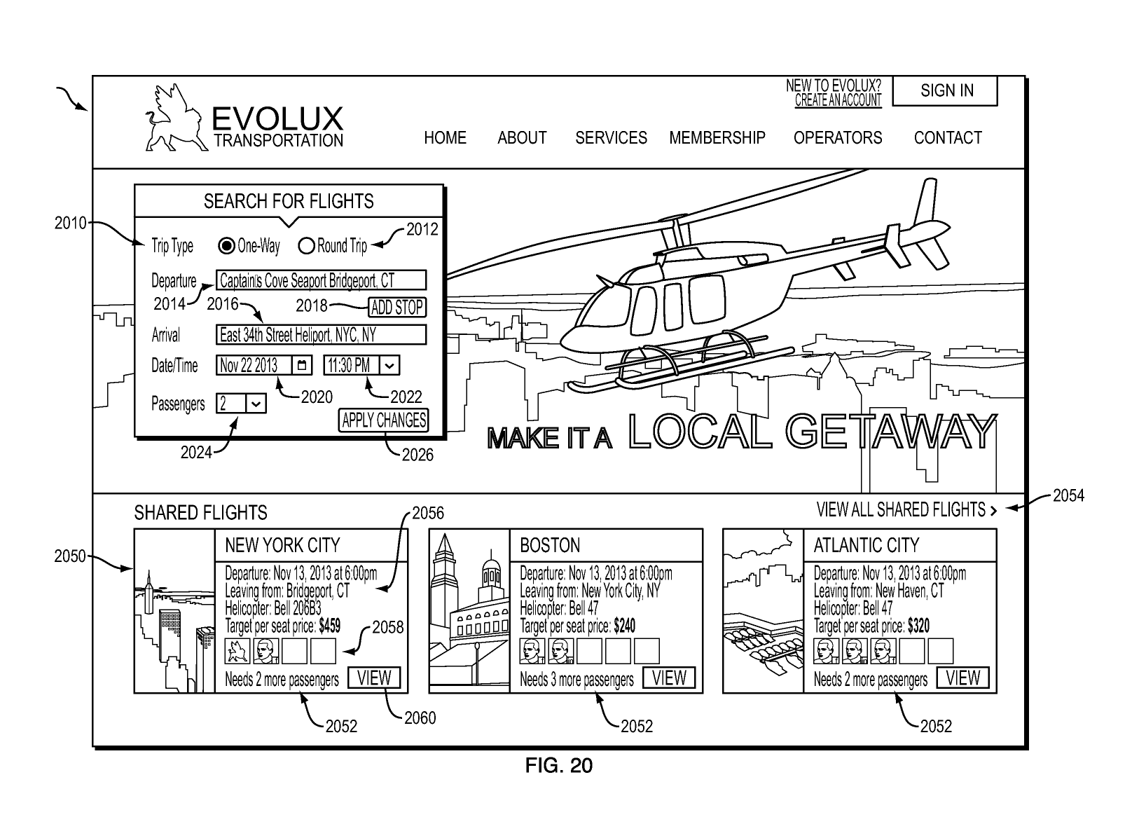

FIG. 20 is an exemplary GUI 2000 that can be provided by an exemplary embodiment of the environment 100 (e.g., via the user interface 110) to allow a member to enter search criteria and/or to view and interact with shared flights. The GUI 2000 can be programmed and/or configured to include a search area 2010 that allows a member enter search criteria for transportation from a departure location to a destination location and a shared flights area 2050 that allows a member to view aggregate booking requests created by other members that are interested in sharing an aircraft. In some embodiments, the shared transport requests can be display based on the preferred location information specified by the members in their member profiles. The GUI 2000 can be programmed and/or configured to interact with embodiments of the environments 102, 130, and/or 140 to facilitate populating and/or verification of the information output by, or input to, the search area 2010 and the shared flights area 2050 of the GUI 2000 as well as to other GUIs which may be displayed in response to inputs received by the member via the GUI 2000.

The search area 2010 includes data entry fields 2012, 2014, 2016, 2018, 2020, 2022, 2024, and 2026 that are configured to be populated in response to information received from the member and/or in response to information programmatically generated by the environment 100. The data entry field 2012 can provide a field that allows the member to select a trip type (e.g., one-way or round trip). In exemplary embodiments, the data entry field 2012 can include a radio button that can be selected by the member to indicate that the member intends to search for aircraft available to be chartered for one-way flights and a radio button that can be selected by the member to indicate that the member intends to search for aircraft to be chartered for round trip flights.

The data entry field 2014 can provide a field that allows the member to specify a location from which the member wishes to depart (i.e. a departure location). In present embodiment, the data entry filed 2014 can be a text box that can be populated with text through a keyboard (physical or virtual) or a microphone and a speech-to-text service. The text box can be configured to provide an auto-complete function to provide departure location options to the member matching the text as the text is being populated in the text box. In some embodiments, the data entry field 2014 can be a dropdown menu that includes a list of available departure locations from which the member can choose. In some embodiments, the member can specify a custom departure location.

The data entry field 2016 can provide a field that allows the member to specify a location at which the member wishes to arrive (i.e. a destination location). In the present embodiment, the data entry filed 2016 can be a text box that can be populated with text in a manner similar to the text box described with respect to the data entry field 2014. In some embodiments, the data entry field 2014 can be a dropdown menu that includes a list of available arrival locations from which the member can choose. In some embodiments, the member can specify a custom arrival location. The data entry field 2018 can be an “Add Stop” button that can be selected by a member to allow the member to specify stops or hops between the departure location and the destination location. In exemplary embodiments, the GUI 2000 can be programmed and/or configured to display data entry fields that allows the member to specify intermediate arrival locations on the way to the final arrival location.

The data entry fields 2020 and 2022 can provide fields that allow the member to specify a departure date and time, respectively. The data entry field 2020 can be populate with a date, for example, in response to a selection of a date from a calendar that is displayed in response to selecting the data entry field 2020 and the data entry field 2022 can be populated, for example, in response to a selection of a time from a dropdown menu. For a one-way trip, the search area 2010 can display data entry fields 2020 and 2022 to allow the user to enter a single date and time. For a round trip or multi-stop trip, the search area can display multiple instances of data entry fields 2020 and 2022 (e.g., one for departure time).

The data entry field 2024 can be a field that allows the member to specify a number of passengers and the data entry field 2026 can be a field that allows the member to submit the search criteria entered in data entry fields 2012, 2014, 2016, 2018, 2020, 2022, and 2024 to the transportation search engine 140. The data entry field 2024 can be a drop down menu that includes a list of numbers from which the member can choose. The data entry field 2026 can be a button that is selectable by the user. Upon selection of the button 2026, the environment 100 can verify that the search criteria entered by the member is valid. If it is not valid, the environment 100 can be programmed and/or configured to prompt the user to change or correct the search criteria or to provide information that would allow the environment 100 to initiate a verification of the search criteria (e.g., when a user enters a custom departure or arrival location). If the search criteria is valid, the environment 100 can be programmed and/or configured to navigate to another GUI interface programmed and/or configured to display the results of the search for flights.

The shared flights area 2050 can display one or more aggregate booking requests created by other members who wish to share a non-schedule chartered flight from a specified departure location to a specified destination location, on a specified date, and at a specified departure time. The shared flights area 2050 can include information for each aggregate booking request 2052 displayed in the GUI 2000. In some embodiments, featured or selected aggregate booking requests can be displayed in the GUI based on, for example, the operators for the aggregate booking requests, the viewing member's preferences, the viewing member's past trips or searches, a relationship between the viewing member and the members that shared the requests, a relationship between the viewing member and other members that joined the aggregate booking requests, a price per seat of the aggregate booking requests, departure locations of the aggregate booking requests, destination locations of the aggregate booking requests, departure dates and/or times of the aggregate booking requests, and/or any other suitable parameters. In some embodiments, the GUI 2000 can include a link 2054 that can be selected by the member to expand the number of aggregate booking requests being displayed in the GUI 2000 or to navigate to another GUI to view additional aggregate booking requests.

The aggregate booking requests 2052 displayed to the member can include information, such as proposed flight information 2056 (e.g., a departure location, date, and time; a type of aircraft being used for the flight, and/or a price per seat for the flight). The aggregate booking requests 2052 displayed to the member can also display passenger information 2058 including, for example, the names and/or images of the members that have joined the aggregate booking requests, the number of passengers need to satisfy the shared flight criteria specified by one or more of the members that have already joined the aggregate booking request, and/or the remaining number of seats available on the aircraft being used for the aggregate booking request. A button 2060 can be provided for each displayed aggregate booking request to allow the member to select the button to navigate to another GUI to view additional information about the aggregate booking request and/or to facilitate social interaction with other members that have joined the aggregate booking request and/or that are viewing the aggregate booking request.

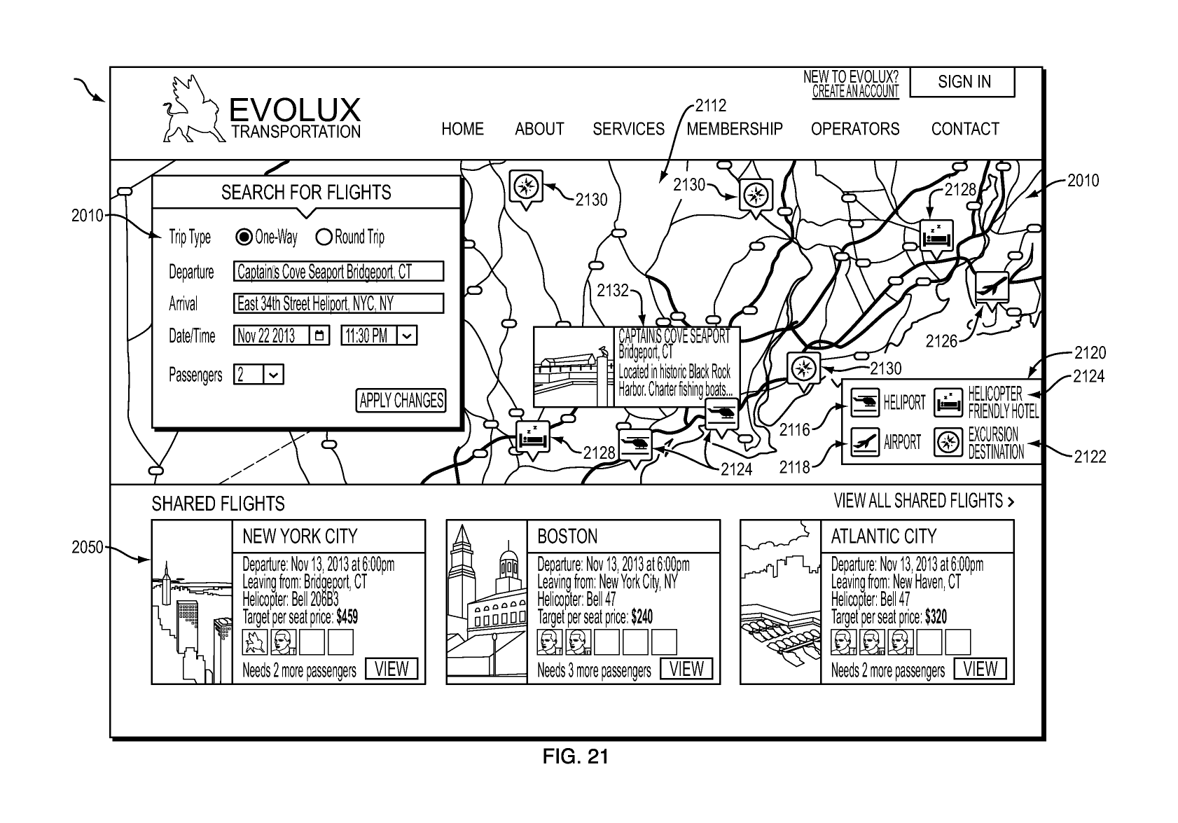

FIG. 21 is an exemplary GUI 2100 that can be provided by an exemplary embodiment of the environment 100 (e.g., via the user interface 110) to allow a member to enter or select search criteria and/or view and interact with shared flights. The GUI 2100 can be programmed and/or configured to interact with embodiments of the environments 120, 130, and/or 140 to facilitate populating and/or verification of the information output by, or input to, the search area 2010 and the shared flights area 2050 of the GUI 2100 as well as to other GUIs, which may be displayed in response to inputs received by the member via the GUI 2100, and to provide a graphical rendering of departure/arrival locations.

As shown in FIG. 21, the GUI 2100 can include the search area 2010 and shared flights area 2050 as described herein, and can include a graphical information area 2110 that can be used to view departure/arrival locations on a geographic map 2112 and/or to view information related to departure/arrival locations. For example, the geographic map 2112 can have a legend 2114 including icons that classify departure/arrival locations, such as a heliport icon 2116, an airport icon 2118, a helicopter friendly hotel icon 2120 (e.g., hotels that have a helicopter landing pad), an excursion destination icon 2122 (e.g., non-traditional departure/arrival locations, such as vineyards, golf courses, etc.). In some embodiments, the icons 2116, 2118, 2120, and/or 2122 can be color coded. While the geographic map includes icons 2116, 2118, 2120, and 2122, those skilled in the art will recognize that more or fewer icons can be specified to classify departure/arrival locations.

The instances of the icons 2116, 2118, 2120, and 2122 can be overlaid on the geographic map 2112 at geographic locations by the search engine 420 based on the class of departure/arrival location associated with the geographic locations. For example, instances of the icon 2116 can be programmatically overlaid on the geographic map 2112 at geographic locations 2124 by the environment 100 to indicate that the geographic locations 2124 are heliports. Instances of the icon 2118 can be programmatically overlaid on the geographic map 2112 at geographic locations 2126 by the environment 100 to indicate that the geographic locations 2124 are airports. Instances of the icon 2120 can be programmatically overlaid on the geographic map 2112 at geographic locations 2128 by the environment 100 to indicate that the geographic locations 2128 are hotel friendly hotels. Instances of the icon 2122 can be programmatically overlaid on the geographic map 2112 at geographic locations 2130 by the environment 100 to indicate that the geographic locations 2130 are excursion destinations.

The member can select or hover over one or more of the instances of the icons 2116, 2118, 2120, and 2122 to view additional information about the geographic locations 2124, 2126, 2128, and 2130, respectively. For example, a member can select an instance of the icon 2116 overlaying one of the geographic locations 2124 to view an information area 2132 describing the selected geographic location. In exemplary embodiments, the member can select instances of the icons to specify a departure location and/or an arrival location. As one example, upon selecting an instance of one of the icons, the environment can programmatically insert the geographic location into the data entry field 2014 of the search area 2010 to specify the departure location of the search criteria or into the data entry field 2018 of the search area to specify the arrival location of the search criteria.

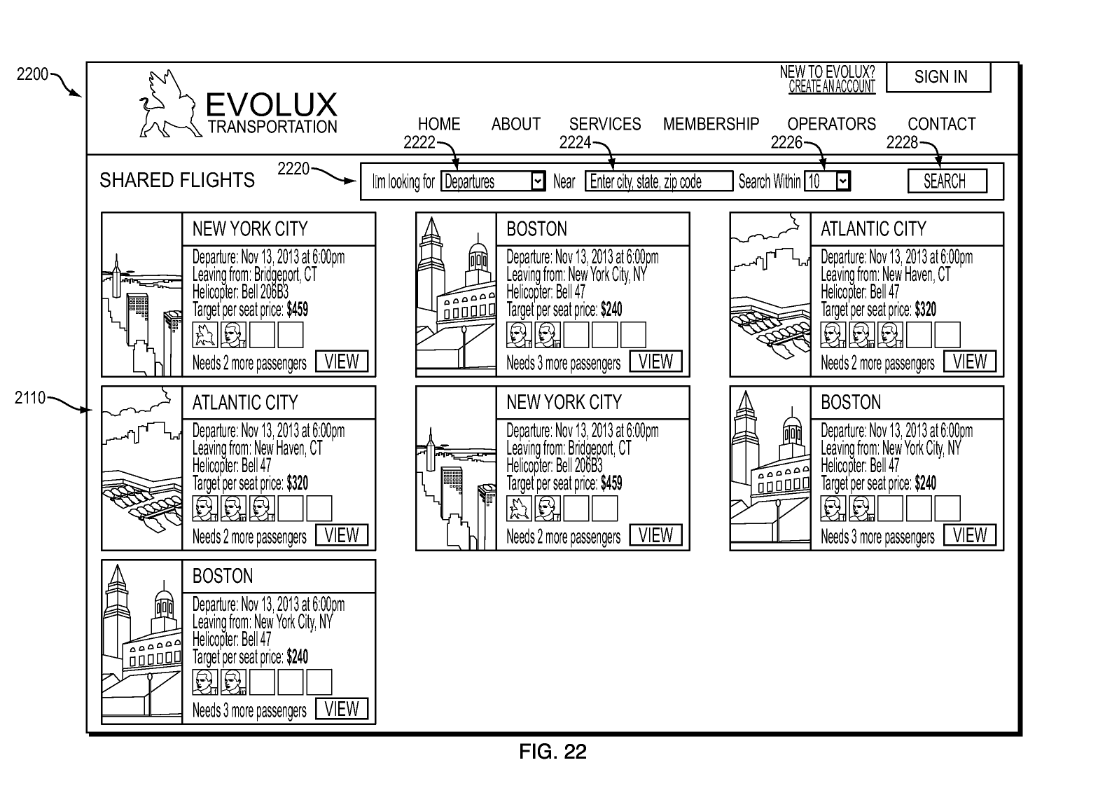

FIG. 22 is an exemplary GUI 2200 showing aggregate booking requests 2210 that have been created by other members of the environment 100. The GUI 2200 can be displayed in response to, for example, a selection of the link 2054 in GUI 2000 shown in FIG. 20. As shown in FIG. 22, the GUI 2200 can include an aggregate booking requests search area 2220 that can allow a member to search for aggregate booking requests based on one or more shared search criteria including, for example, a location type 2222 (e.g., departure and/or destination), location information 2224 (e.g., departure and/or destination locations), a geographic radius 2226 within which to return aggregate booking requests based on the specified location information 2224, and a search button 2228 that can be selected by the member to initiate a search for aggregate booking requests based on the shared flight search criteria.

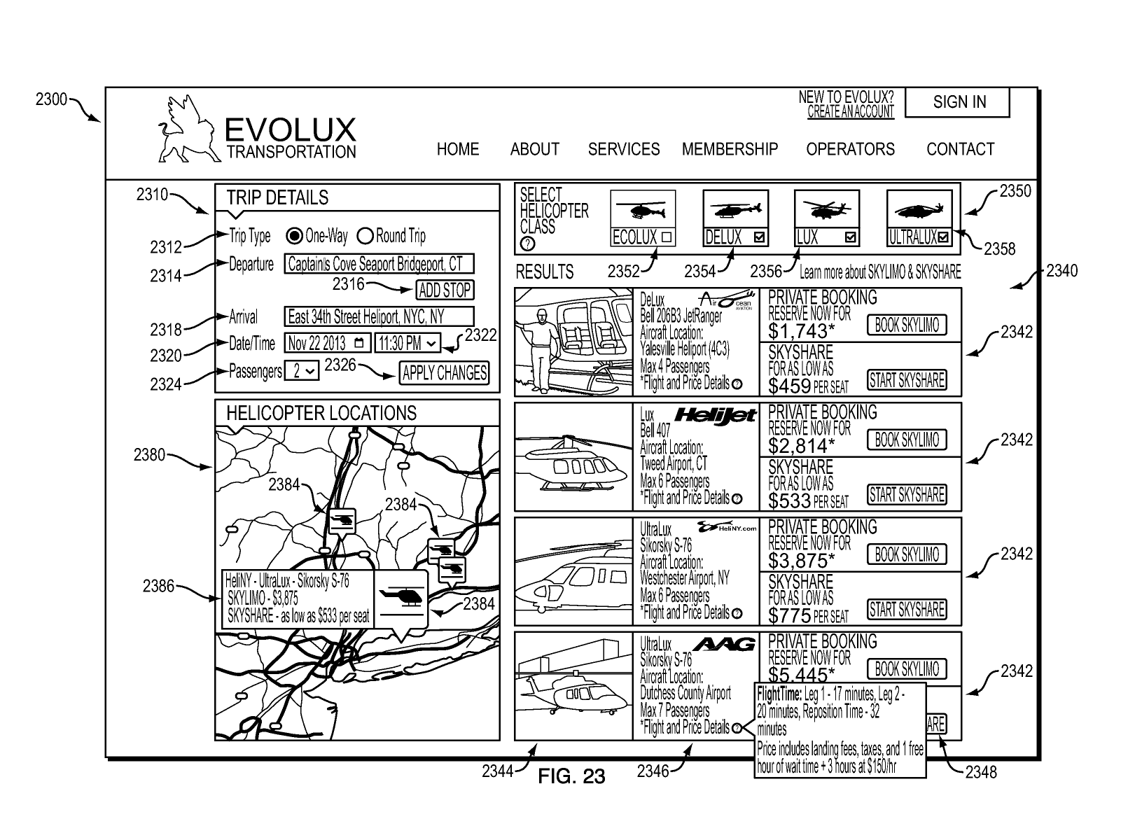

FIG. 23 is an exemplary GUI 2300 that can be provided by an exemplary embodiment of the environment 100 (e.g., via the user interface 110) to allow a member to view and select aircrafts returned in response to a search performed by the environment 100 using search criteria submitted by the member, and to graphically view home locations or current geographic locations of the aircrafts. The GUI 2300 includes a trip details area 2310, a search results area 2330, and an aircraft location area 2360. The GUI 2300 can be programmed and/or configured to interact with embodiments of the environments 120, 130, and/140 to facilitate display and selection of one or more flights returned by the search and the current location of aircrafts.

The trip details area 2310 allows the member to change or modify the transportation search criteria when the results are displayed. In exemplary embodiments, the trip details area 2310 can include the data entry fields 2012, 2014, 2016, 2018, 2020, 2022, 2024, and 2026. The data entry fields 2012, 2014, 2016, 2018, 2020, 2022, 2024, and 2026 can be populated with the search criteria previously specified by the member. The information in the data entry fields 2012, 2014, 2016, 2018, 2020, 2022, 2024, and 2026 can be changed and/or modified by the member. After the member changes or modifies the information, the user can select the data entry field 2026 (e.g., a button) to apply the changes to the search criteria. In response to the selection of the data entry field 2026, the environment 100 can be programmed and/or configured to update the results displayed in the sear results area 2330 and the aircraft locations in the aircraft location area 2360.

The search results area 2330 can include a list 2340 of results 2342 that are returned by the environment 100 in response to the search criteria specified by the member. Each result 2342 in the list can include aircraft information, operator information, price information, and the like. For example, each result 2342 in the list 2340 can include an image 2344 (e.g., an image of the aircraft that can be booked), flight information 2346 (e.g., a type of aircraft, a location of the aircraft, a number of passengers that aircraft can transport, travel time from the aircraft location to the arrival location, and the like), a booking portion 2348 including a price for booking the aircraft for the member's use, an price for booking a seat on the aircraft and sharing the aircraft with other members, and/or links for starting the aircraft booking process.

The search results area 2330 can allow the member to filter the results based on one or more parameters. For example, in the present embodiment, the member can filter the results based on the class or type of aircraft that can be booked through a filter portion 2350. The filter portion can include a list of aircrafts returned by the search, which can be represented as graphics including a graphic 2352 corresponding to a first aircraft class or type, a graphic 2354 corresponding to a second aircraft class or type, a graphic 2356 corresponding to a third aircraft class or type, and a graphic 2358 corresponding to a fourth aircraft class or type. The member can select one or more the graphics to include aircraft classes or types in the search results and/or can deselect one or more of the graphics to exclude aircraft classes or types in the search results.

The aircraft location area 2380 can provide the member with information about a location of the aircrafts returned in the results. For example, the aircraft location area 2380 can include a geographic map 2382. Icons 2384 representing the aircrafts can be overlaid on the geographic map by the search engine 420 to indicate a location at which the aircraft is a currently located (i.e. a current location) and/or a location at which the aircraft will be at the departure date and time (i.e. an expected location). The member can select or hover over the icons to view information 2386 about the aircraft including, for example, an aircraft class or type, an operator of the aircraft, prices for booking the aircrafts, and the like). The location information can be provided by the operators of the aircrafts and/or can be determined automatically based a GPS signals. For embodiments that provide the current location of the aircraft automatically, the icons 2384 overlaying the geographic map 2382 can move as the location of the aircraft moves to show a change in location of the aircraft. Providing the current location and/or expect location of the aircrafts returned in the search can be used by the member when determining which aircraft to book and/or which departure location to select.

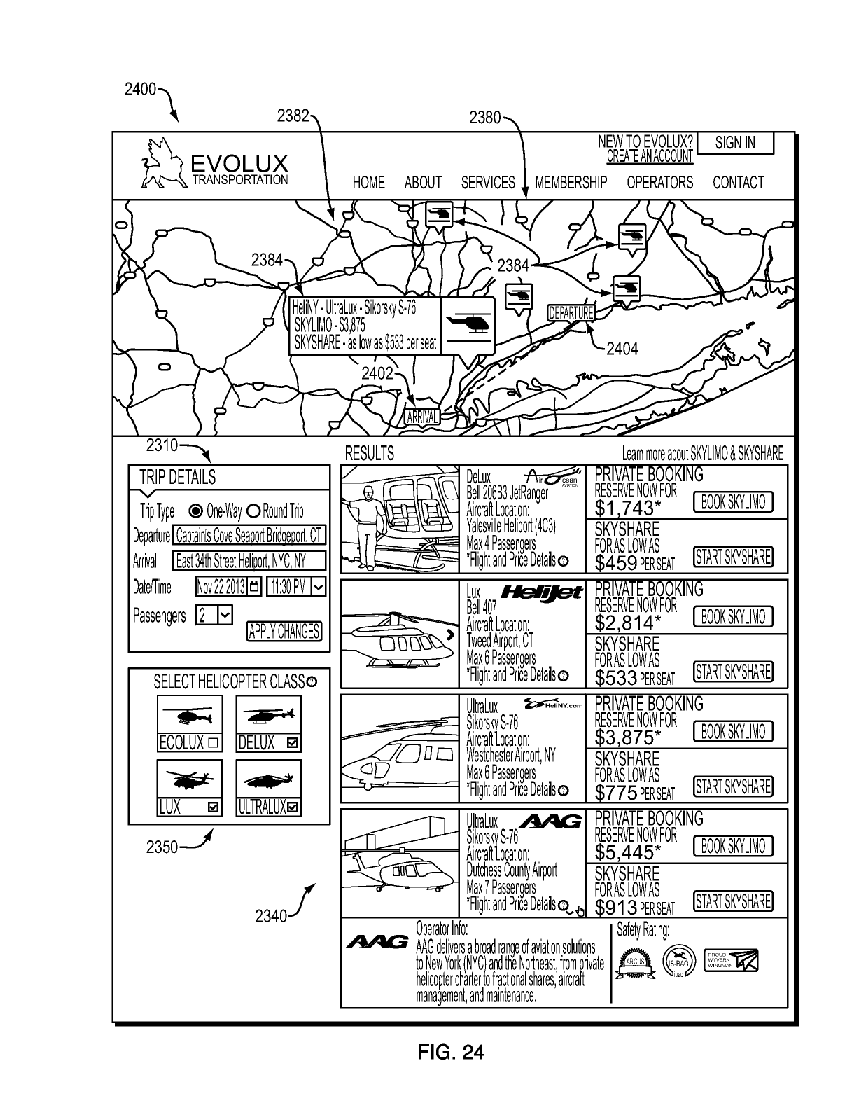

FIG. 24 is an exemplary GUI 2400 that can be provided by an exemplary embodiment of the environment 100 (e.g., via the user interface 110) to allow a member to view and select aircrafts returned in response to a search performed by the environment using search criteria submitted by the member, and to view current geographic locations of aircrafts in relation to the departure and arrival locations selected by the member. The GUI 2400 includes the trip details area 2310, the search results area 2330, and the aircraft location area 2380, as described herein. The GUI 2300 can be programmed and/or configured to interact with embodiments of the environments 120, 130, and/or 140 to facilitate display and selection of one or more flights returned by the search and the current location of aircrafts. As shown in FIG. 24, the aircraft location area 2380 can include an indicator 2402 overlaid on the geographic map 2382 to identify the departure location selected by the member and can include an indicator 2404 overlaid on the geographic map 2382 by the search engine 420 to identify the arrival location selected by the member. Overlaying the indicators 2402 and 2404 and the icons 2384 on the geographic map 2382 by the environment 100 can provide the member with information that can be used by the member when determining which aircraft to book. For example, the member can view the indicators 2402 and 2404 and the icons 2384 to determine whether a different departure or arrival location would be better than the specified departure or arrival location (e.g., because an aircraft will be available at a location that is closer to the members location or will be available at a more convenient time than the aircrafts at the specified departure or arrival locations).

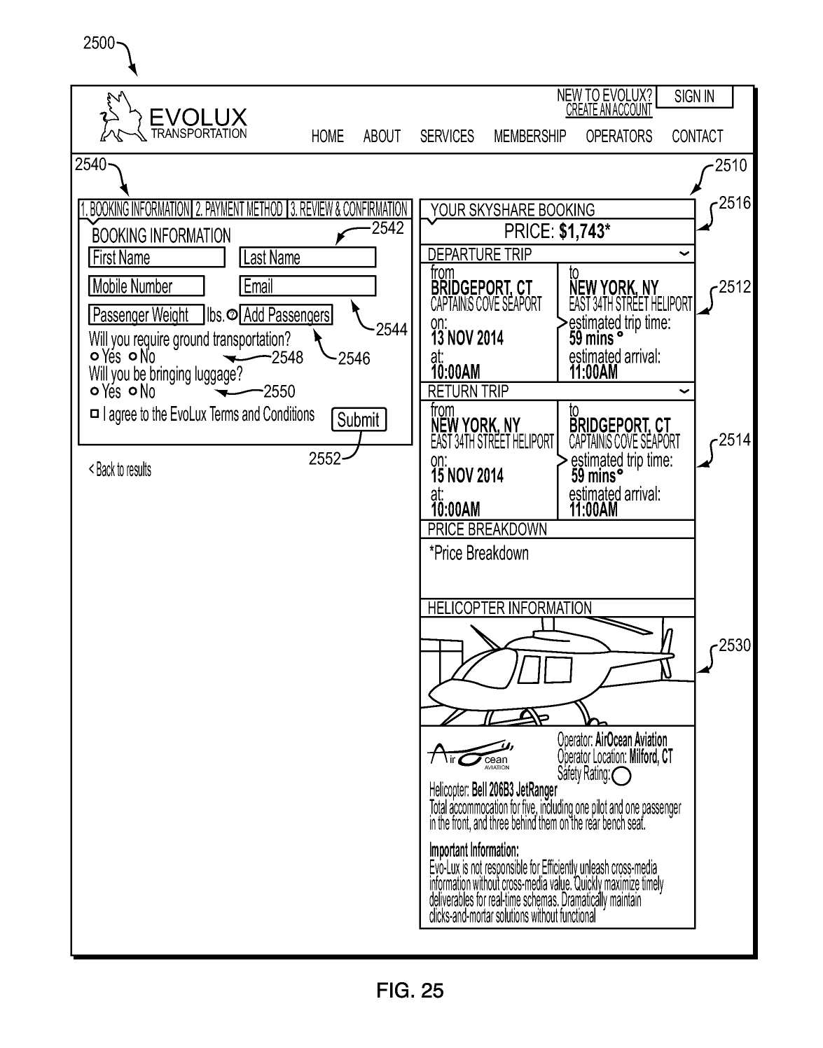

FIG. 25 is an exemplary GUI 2500 that can be provided by an exemplary embodiment of the environment 100 (e.g., via the user interface 110) in response to a selection by the member to book an entire chartered aircraft for a non-scheduled chartered flight. The GUI 2500 can facilitate an interaction between the member and the booking manager 240 such that the booking information received from the member is processed by the booking engine 242 to generate a non-aggregated booking request that is presented to the operator associated with the aircraft to be booked via the operator dashboard engine 310. The GUI 2500 includes a chartered flight information area 2510 that includes information related to a proposed chartered flight and a booking information area 2540 including data entry fields to allow the member to enter booking information.

The area 2510 of the GUI 2500 can include information 2512 about the departure trip including a departure location, date, and time; an destination location; a total flight time; and an estimated arrival time. The area 2510 can include return trip information 2514 that provides similar information as the departure trip information and can include price information 2516 providing a total price for chartering a selected aircraft between the departure and destination locations. The area 2510 can include operator information 2530 including, for example, an operator of the aircraft, a location of the operator, a safety rating of the operator, a class or type of the aircraft, and the like.

The area 2540 can displayed to request booking information 2542 from the member. The booking information requested from the member can be entered in data entry fields 2544, 2548, and 2550. For example, the data entry fields 2544 can request passenger information (e.g., name, phone number, e-mail address, weight, and the like), and can allow the member to enter passenger information for additional passengers upon selection of the data entry field 2546. The area 2540 can include data entry fields 2548 and 2550 to determine whether the member will require ground transportation and whether the member intends to bring luggage. After providing the booking information 2542, the member can select the submit button 2552 to navigate to another GUI to allow the member to enter payment information.

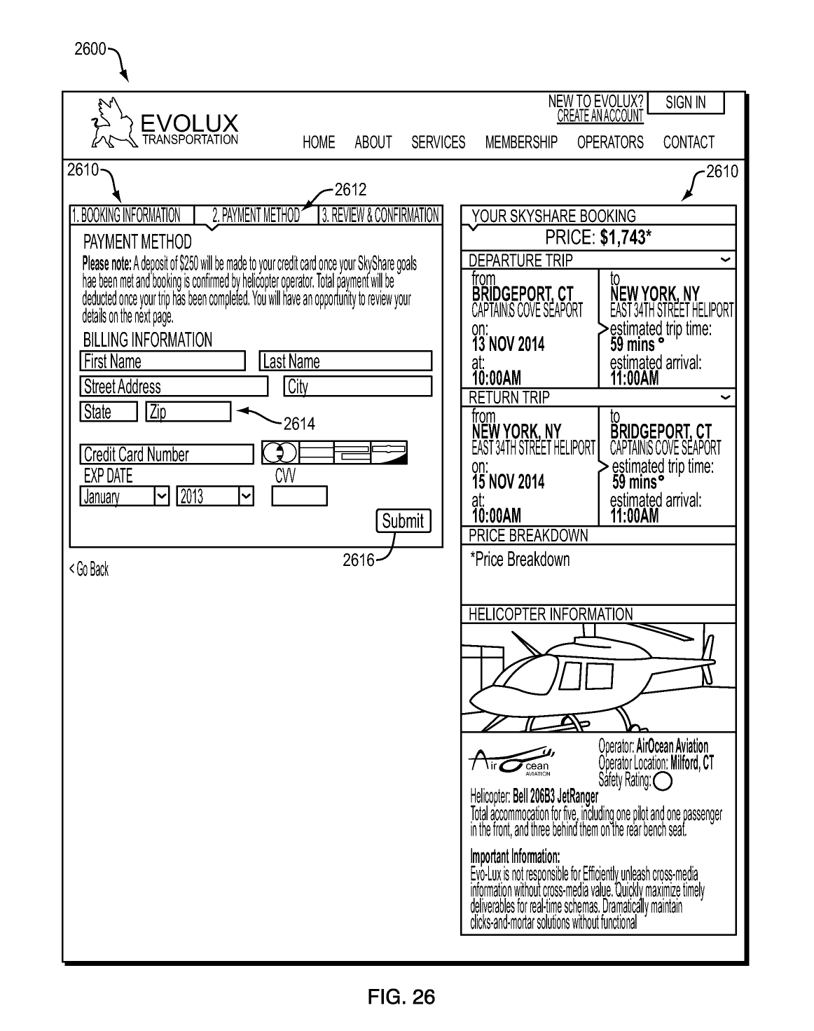

FIG. 26 is an exemplary GUI 2600 that can be provided by an exemplary embodiment of the environment 100 (e.g., via the user interface 110) in response to submitting booking information for a shared flight (e.g., a selection of the submit button 2552 shown in FIG. 25). The GUI 2600 includes the informational area 2510 and a payment information area 2610 including data entry fields to allow the member to enter payment information. The GUI 2600 can be programmed and/or configured to interact with embodiments of the environments 120, 130, and/or 140 to facilitate payment for a chartered aircraft to be used for a non-scheduled chartered flight.

The area 2610 can be displayed to request payment information 2612 from the member. The payment information 2612 requested from the member can be entered in data entry fields 2614. For example, the data entry fields 2614 can request billing information including a name, phone number, street address, e-mail address, credit card number, credit card expiration date, and the like. After providing the payment information 2612, the member can select a submit button 2616 to navigate to another GUI to allow the member to review and confirm the booking and payment information entered by the member.

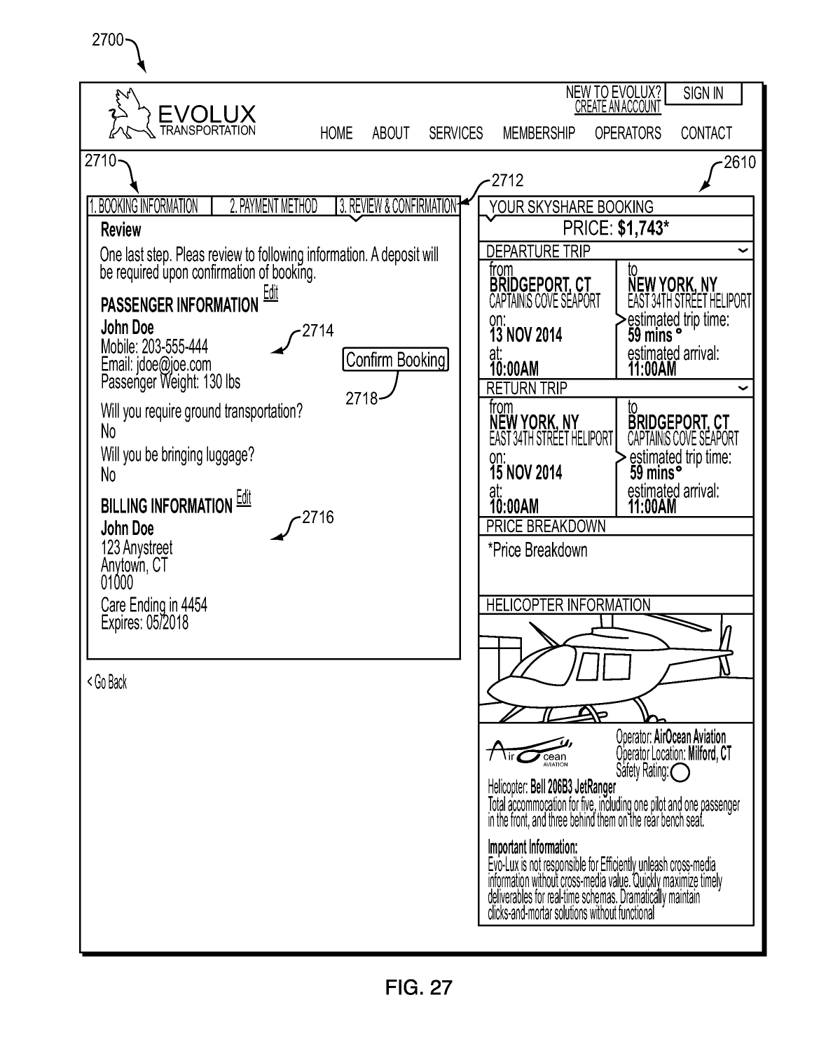

FIG. 27 is an exemplary GUI 2700 that can be provided by an exemplary embodiment of the environment 100 (e.g., via the user interface 110) in response to submitting payment information for a chartered aircraft to be used for a non-scheduled chartered flight (e.g., a selection of the submit button 2616 shown in FIG. 26). The GUI 2700 includes the informational area 2510 and a confirmation area 2710 including data output areas to allow the member to review and confirm billing and payment information previously entered by the member. The area 2710 can display passenger information 2714 based on the passenger information previously entered by the member (e.g., via the GUI 2500) and can display the payment information 2716 previously entered by the member (e.g., via the GUI 2600). To submit a non-aggregate booking request to charter an aircraft, the member can select a confirm button 2718.

The GUI 2700 can be programmed and/or configured to interact with embodiments of the environments 120, 130, and/or 140 to facilitate submission of a non-aggregate booking request for a chartered aircraft to be used for a possible non-scheduled chartered flight. For example, in response to a selection of the button 2718 in GUI 2700 of FIG. 27, the booking manager 240 of the administrator environment 120 can notify the operator associated with the aircraft identified in the non-aggregate booking request that the member wishes to charter the entire aircraft for a trip. Once acceptance of the non-aggregate booking request is received by the booking manager 240, the booking manager (e.g., via the booking engine 242) can notify the member that the chartered aircraft has been booked.

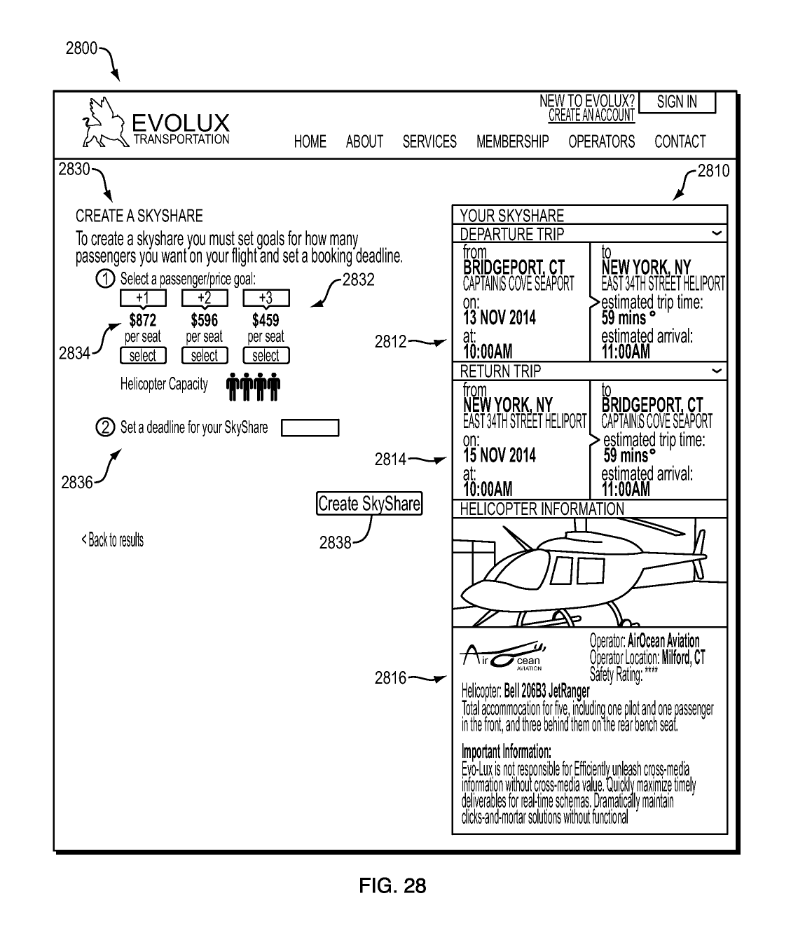

FIG. 28 is an exemplary GUI 2800 that can be provided by an exemplary embodiment of the environment 100 (e.g., via the user interface 110) in response to a selection by the member to book a chartered aircraft for a shared non-scheduled chartered flight. The GUI 2800 can facilitate an interaction between the member, the shared transportation engine 430, and the booking manager 240 such that the shared flight information received from the member via the GUI 2800. As one example, the information received by the GUI 2800 can be used by the shared transportation engine 430 to generate an aggregate booking request. The aggregate booking request can be shared using one or more social media sites (e.g., Facebook, Twitter, LinkedIn, Google+, etc.) and can include information about the proposed trip including a threshold number of passengers that must join the proposed shared flight before the booking manager 240 presents the aggregate booking request to the operator, e.g., via the operator dashboard engine 310.

The GUI 2800 includes a chartered flight information area 2810 that includes information related to a proposed shared chartered flight and a shared flight creation area 2830 including data entry fields to allow the member to enter shared flight criteria 2832. The area 2810 of the GUI 2800 can include information 2812 about the departure trip including a departure location, date, and time; an destination location; a total flight time; and an estimated arrival time. The area 2810 can include return trip information 2814 that provides similar information as the departure trip information. The area 2810 can include operator information 2816 including, for example, an operator of the aircraft, a location of the operator, a safety rating of the operator, a class or type of the aircraft, and the like.

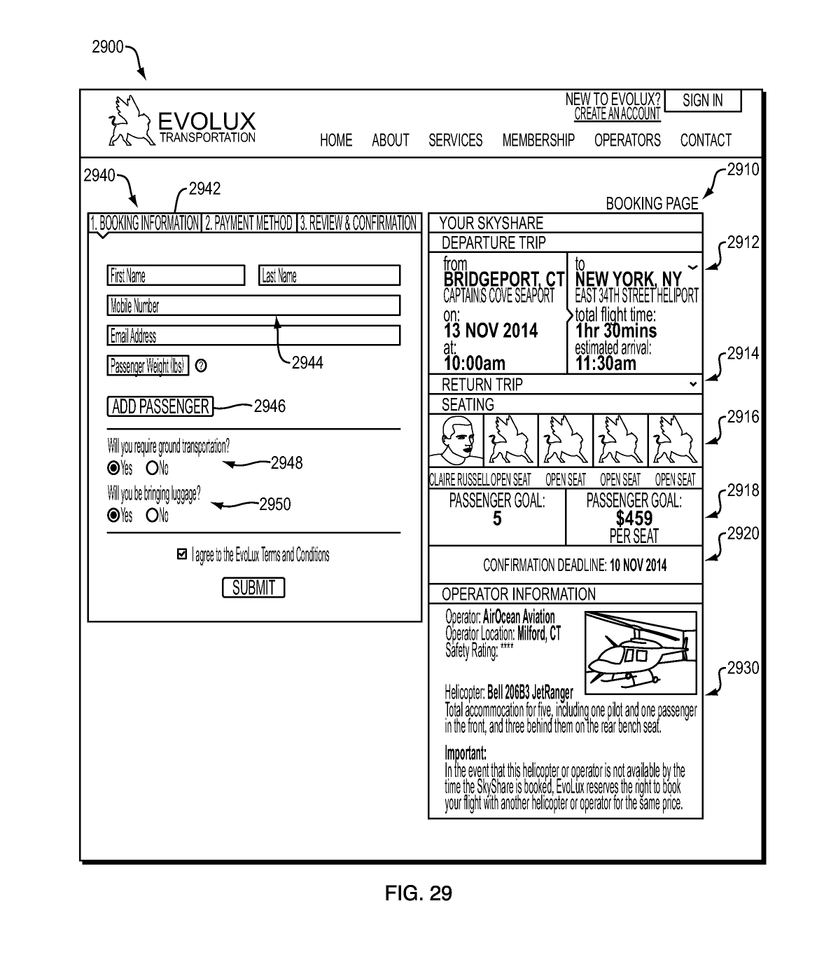

The area 2830 can be displayed to request shared flight criteria from the member. The shared flight criteria can be entered in data entry fields 2834, 2836, and 2838. The data entry fields 2834 can allow the member creating the aggregate booking request to specify a goal or threshold number of passengers and/or a goal or threshold price for the chartered aircraft. For example, in exemplary embodiments of the present disclosure, the member creating the aggregate booking request can specify a minimum number of passengers that need to join the shared flight before an aggregate booking request is presented to the operator of the aircraft to be chartered by the passengers on a per seat basis or before the members can submit the request to the booking engine 242. The minimum number of passengers can also correspond to a per seat price threshold (e.g., a maximum price that the member wishes to pay for a seat on the aircraft). The data entry field 2836 can allow the member to specify a deadline (e.g., a specific date, a number of days or weeks, etc.) by which the passenger threshold and/or price threshold must be satisfied before an aggregate booking request for the chartered aircraft is presented to the operator or before the members can submit the request to the booking engine 242. In exemplary embodiments, in response to a selection of a data entry field 2838, the environment 100 can be programmed and/or configured to navigate to GUIs (e.g., as shown in FIGS. 29-32) that allow the member to enter booking information that will form a portion of the aggregate booking request to be presented to the operator if the shared flight criteria is satisfied.

FIG. 29 is an exemplary GUI 2900 that can be provided by an exemplary embodiment of the environment 100 (e.g., via the user interface 110) in response to a selection by the member to create, book, or join an aggregate booking request. The GUI 2900 includes an informational area 2910 that includes information related to the aggregate booking request and a booking information area 2940 including data entry fields to allow the member to enter booking information. The GUI 2900 can be programmed and/or configured to interact with embodiments of the environments 120, 130, and/or 140 to facilitate display and selection of one or more flights returned by the search and the current location of aircrafts.

The area 2910 of the GUI 2900 can include information 2912 about the proposed departure trip including a departure location, date, and time; an arrival location; a total flight time; and an estimated arrival time. The area 2910 can include return trip information 2914 that provides similar information as the departure trip information, but for the return trip (if applicable); seating information 2916 identifying passengers, remaining seats and a goal or threshold number of passengers that must join for the aggregate booking request; price information 2918 providing a target price per seat; and deadline information 2920 including a deadline by which the member must confirm to join the aggregate booking request. The area 2910 can include operator information 2930 including, for example, an operator of the aircraft, a location of the operator, a safety rating of the operator, a class or type of the aircraft, and the like.

The area 2940 can displayed to request booking information 2942 from the member. The booking information requested from the member can be entered in data entry fields 2944, 2946, 2948, and 2950. For example, the data entry fields 2944 can request passenger information (e.g., name, phone number, e-mail address, weight, and the like, and can allow the member to enter passenger information for additional passengers upon selection of the data entry field 2946. The area 2940 can include data entry fields 2948 and 2950 to determine whether the member will require ground transportation and whether the member intends to bring luggage. After providing the booking information 2942, the member can select the submit button 2952 to navigate to another GUI to allow the member to enter payment information.

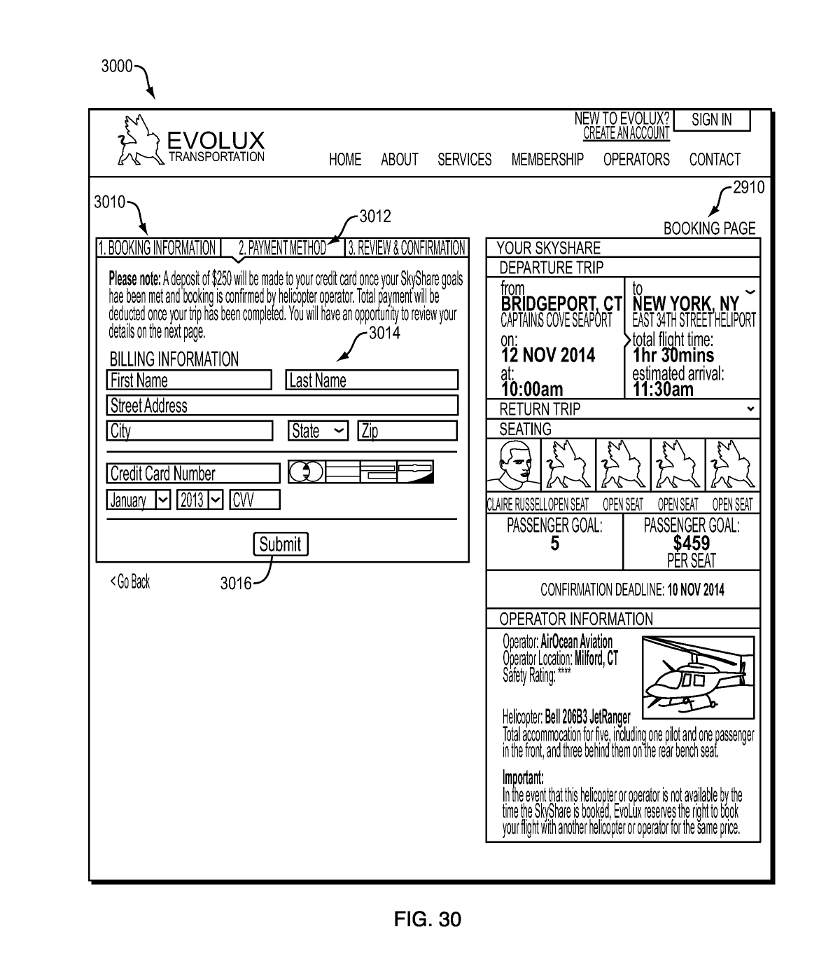

FIG. 30 is an exemplary GUI 3000 that can be provided by an exemplary embodiment of the environment 100 (e.g., via the user interface 110) in response to submitting booking information for a shared flight (e.g., a selection of the submit button 2950 shown in FIG. 29). The GUI 3000 includes the informational area 2910 and a payment information area 3010 including data entry fields to allow the member to enter payment information. The GUI 3000 can be programmed and/or configured to interact with embodiments of the environments 120, 130, and/or 140 to facilitate payment for a shared flight.

The area 3010 can be displayed to request payment information 3012 from the member. The payment information 3012 requested from the member can be entered in data entry fields 3014. For example, the data entry fields 3014 can request billing information including a name, phone number, street address, e-mail address, credit card number, credit card expiration date, and the like. After providing the payment information 3012, the member can select a submit button 3016 to navigate to another GUI to allow the member to review and confirm the booking and payment information entered by the member.

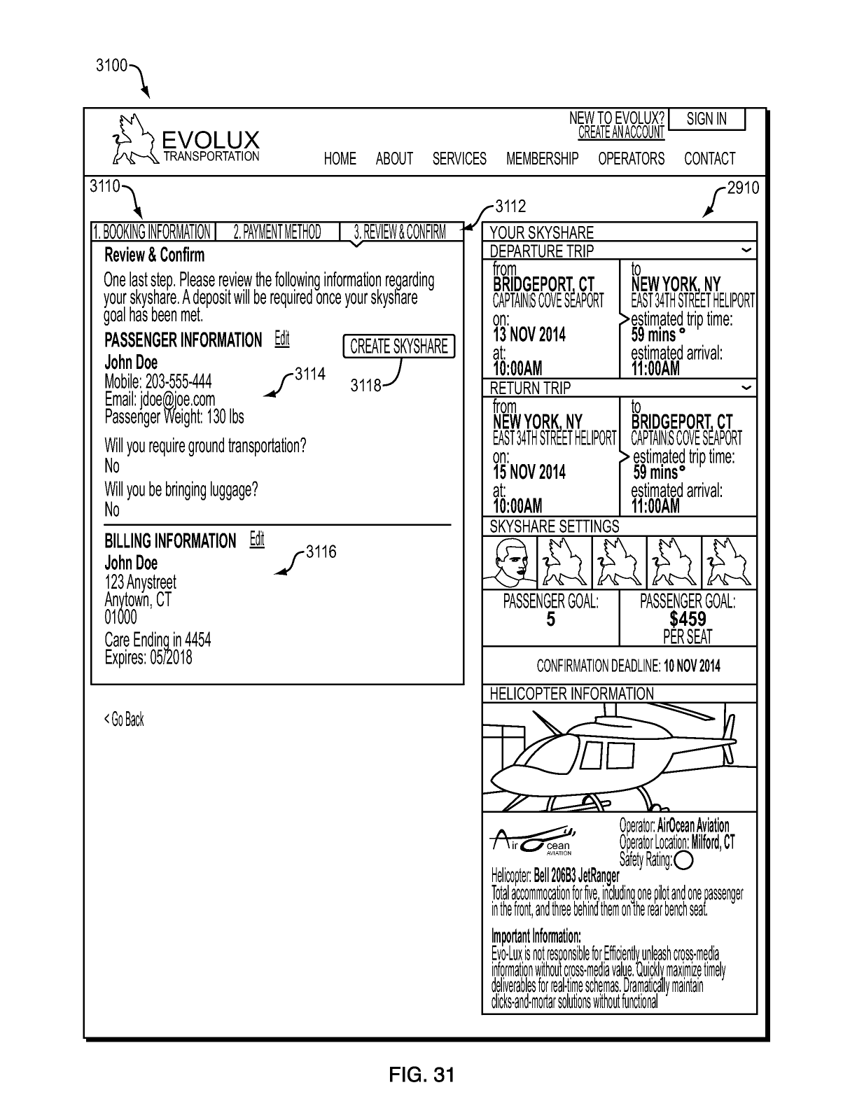

FIG. 31 is an exemplary GUI 3100 that can be provided by an exemplary embodiment of the environment 100 (e.g., via the user interface 110) in response to submitting payment information for a shared flight (e.g., a selection of the submit button 1016 shown in FIG. 10). The GUI 3100 includes the informational area 2910 and a confirmation area 3110 including data output areas. The area 3110 can display passenger information 3114 based on the passenger information previously entered by the member (e.g., via the GUI 2900) and can display the payment information 3116 previously entered by the member (e.g., via the GUI 3000). To create an aggregate booking request, the member can select a button 3118. In response to a selection of the button 3118, an aggregate booking request is created identifying the member as the lead passenger for the aggregate booking request. The aggregate booking request can be shared with other members of the environment 100 and/or to other individuals (e.g., via the member's account on one or more social media sites, such as Facebook, Twitter, LinkedIn, Google+, etc.). In some embodiments, the an aggregate booking request can be presented to the operator after the shared flight criteria is satisfied. In some embodiments, the an aggregate booking request can be presented to the operator before the shared flight criteria is satisfied. The GUI 3100 can be programmed and/or configured to interact with embodiments of the environments 120, 130, and 140 to facilitate creation of an aggregate booking request.

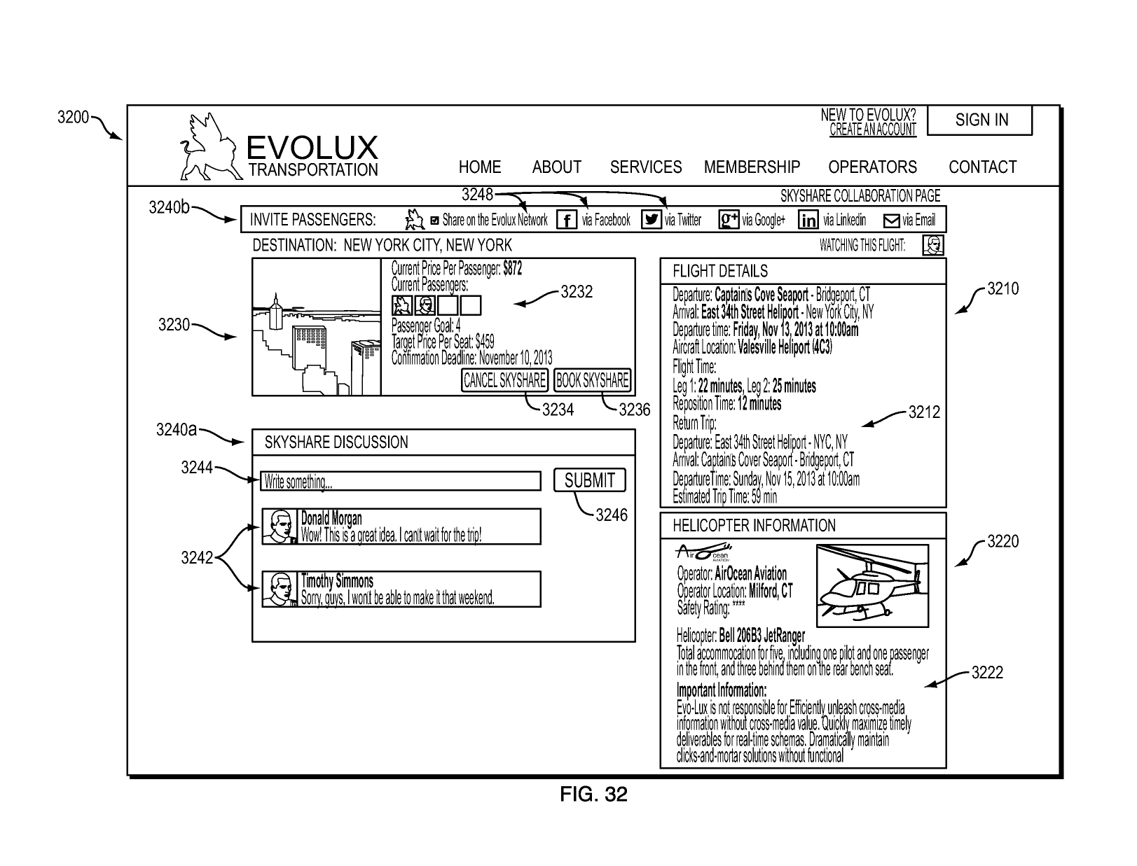

FIG. 32 is an exemplary GUI 3200 that can be provided by an exemplary embodiment of the environment 100 (e.g., via the user interface 110) in response to a selection by the user to create, book, or join an aggregate booking request. The GUI 3200 can include a proposed flight details area 3210, an aircraft information area 3220, a shared flight information area 3230, and social interaction areas 3240a-b. The GUI 3200 can be programmed and/or configured to interact with embodiments of the environments 120, 130, and/or 140 to facilitate viewing, creating, and/or joining aggregate booking requests.

The flight details area 3210 can include information 3212 about the proposed flight including, for example, departure locations, arrival locations, departure dates and times, flight times, and the like associated with the proposed flight including any stops or hops and return trips included in the flight. The aircraft information area 3220 can include information 3222 about the aircraft being chartered for the proposed flight. The information 3222 can include, for example, an operator of the aircraft, a location of the operator, a safety rating of the operator, a class or type of the aircraft, and the like.

The shared flight information area 3230 can include information 3232 including, for example, a price per passenger for the shared flight, other members that have already joined the aggregate booking request (e.g., passengers), a goal or threshold for the number of passengers, a deadline by which the member must book (e.g., join) the shared flight. The area 3230 can also include a link 3234 that allows the member to cancel the aggregate booking request or return to search results and a link 3236 that allows the member to book the proposed shared flight. In some embodiments, the link 3236 is not selectable until the shared flight criteria is satisfied such that the members associated with the aggregate booking request cannot submit the aggregate booking request to the booking engine 242 until the shared flight criteria is satisfied (e.g., until a minimum or threshold number of passengers join the aggregate booking or until a maximum or threshold per-seat price is achieved).

As one example, in some embodiments, if the shared flight criteria of each of the members that joined the aggregate booking request are satisfied, but the shared flight criteria of the member that created the aggregate booking request has not been satisfied, the link 3236 can be configured (e.g., via the user interface 110 in response to instructions from the booking manager 240) to be selectable by the member that created the aggregate booking request, but not the members that joined the aggregate booking request. By allowing the member that created the aggregate booking request select the link 3236, exemplary embodiments of the environment 100 can be programmed to advantageously allow the creator of an aggregate booking request to override the threshold he/she specified when the aggregate booking request was created when the shared flight criteria specified by each of the members that joined the aggregate booking request have been satisfied.

The social interaction area 3240a can be programmed and/or configured to display comments 3242 from people with whom information about the aggregate booking request has been shared and/or that have viewed the shared flight. The social interaction area 3240a can include a data entry field 3244 that allows the member to provide a comment that can be posted in the comment stream of the area 3240a upon selection of a submit button 3246. In some embodiments, the comment can also be distributed to the member's friends, contacts, or connections in the member's social network (e.g., a network maintained by the environment 100, Facebook, Twitter, Google+LinkedIn, and the like).

The social interaction area 3240b can be programmed and/or configured to allow the member to invite passengers to join the aggregate booking request. The social interaction area 3240b can include options 3248 that the member can select to specify how the member wishes to invite passengers to join the aggregate booking request. For example, in the present embodiment, the options 3248 that can be selected by the user can include an option to invite people that use the environment 100 (e.g., other members). In some embodiments, the environment 100 can be structured as a social network such that the member can be connected to people in the environment 100 (e.g., as “friends”, “connections”, or “contact”). The member can choose to invite only those people the member has a relationship, a subset of the people with whom the member has a relationship, with everyone that uses the environment, and the like. In some embodiments, the options 3248 that can be selected by the user can include options to invite people to join the aggregate booking request using one or more external social media sites, such as Facebook, Twitter, Google+, LinkedIn, and the like. Upon selection of any of these options, the environment 100 can programmatically interact with the external social media sites to facilitate posting the invite to the external social media sites to disseminate the invitation to join the aggregate booking request to people on the social media sites that are within the members social network (e.g., friends on Facebook, followers on Twitter, connections on LinkedIn, etc.). In some embodiments, the options can also include an option to e-mail the invitation to join the aggregate booking request to others.

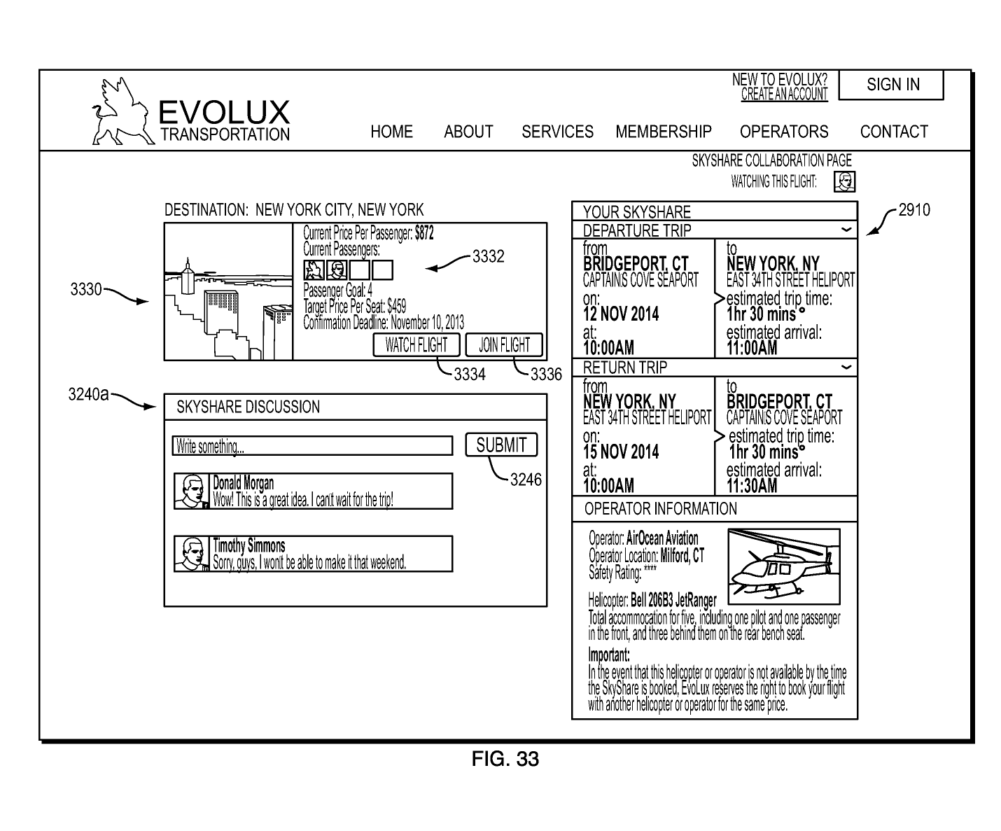

FIG. 33 is an exemplary GUI 3300 that can be provided by an exemplary embodiment of the environment 100 (e.g., via the user interface 110) to facilitate viewing, monitoring, and/or joining an existing aggregate booking request. The GUI 3300 includes the social interaction area 3240a, the informational area 2910, and an aggregate booking request information area 3310. The area 3310 can include information related to the aggregate booking request including, for example, a current price per passenger or seat, a target price per passenger or seat, passenger information, a remaining number of seats, a goal or threshold number of seat to be filled before the aggregate booking request is confirmed, deadline by which the member must confirm to join the aggregate booking request, and the like. The area can include a link 3334 that can be selected by the member to add the aggregate booking request to the members shared flight watch list so that the member can track the status of the aggregate booking request including, the current price per passenger or seat, the number of passengers that have joined, the goal or threshold number of passengers required, a difference between the goal or threshold and the number of passengers that have joined, and the like. The area 3310 can include a link 3336 that can be selected by the member to join the aggregate booking request. The GUI 3000 can be programmed and/or configured to interact with embodiments of the environments 120, 130, and/or 140 to facilitate viewing, monitoring, and/or joining the aggregate booking request.

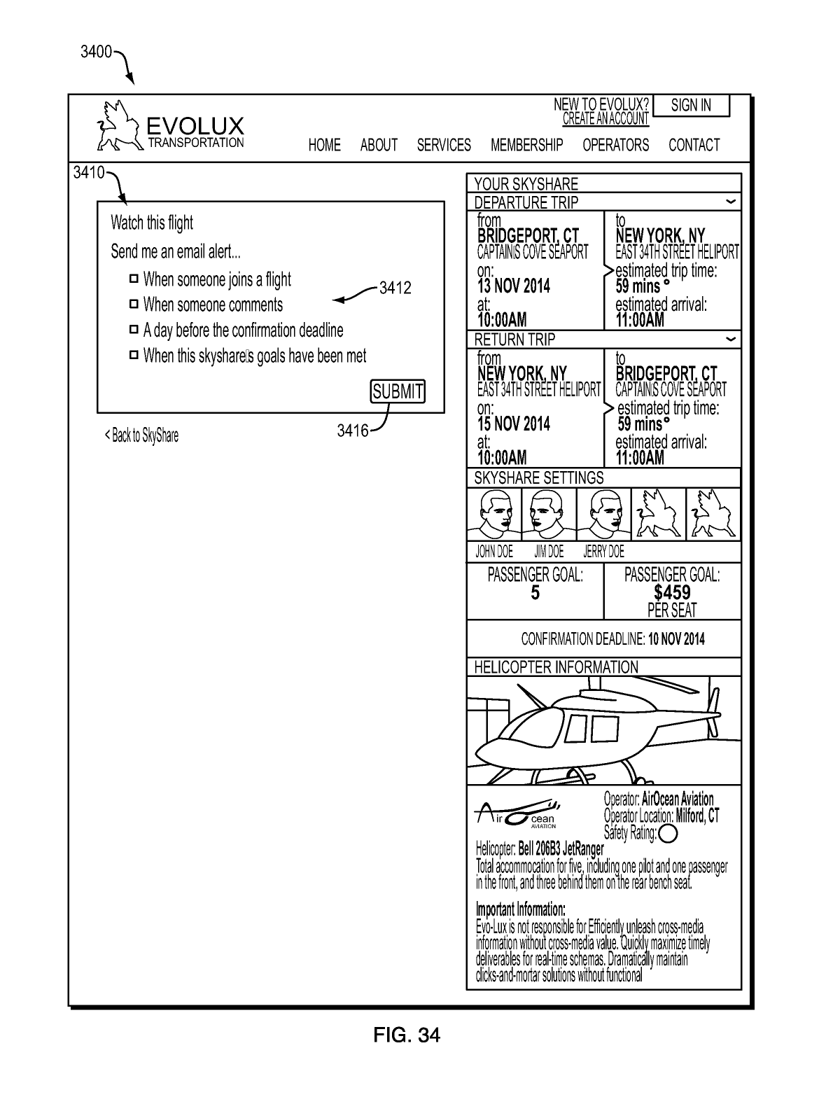

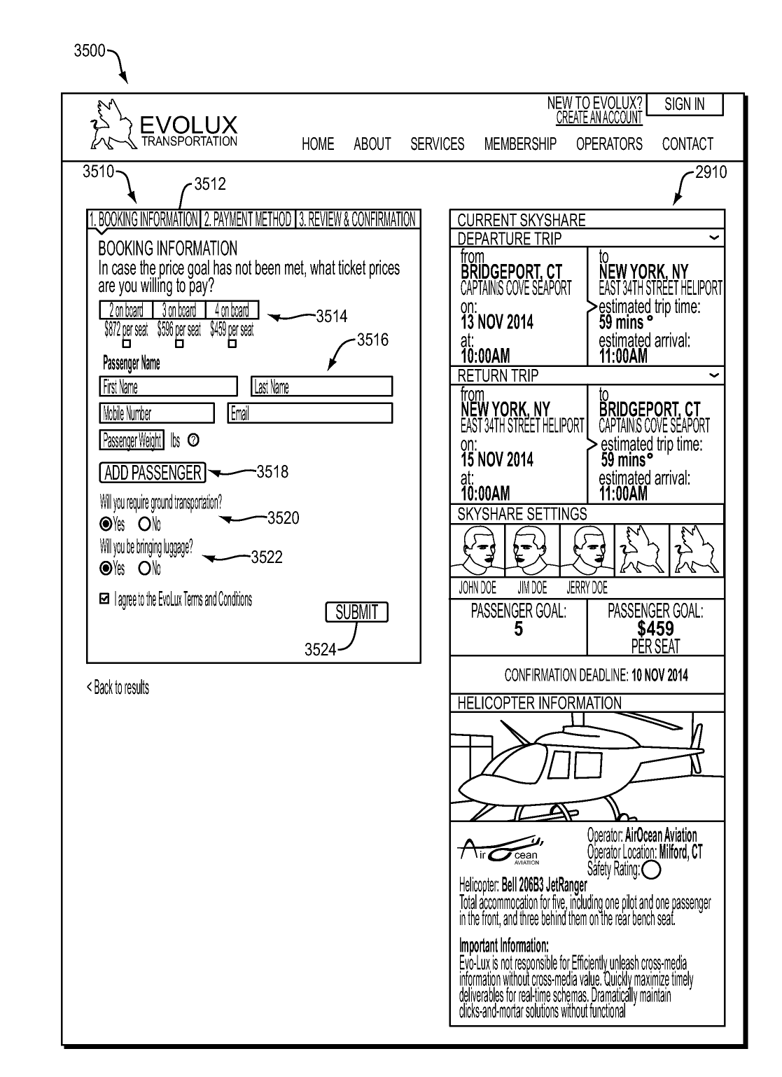

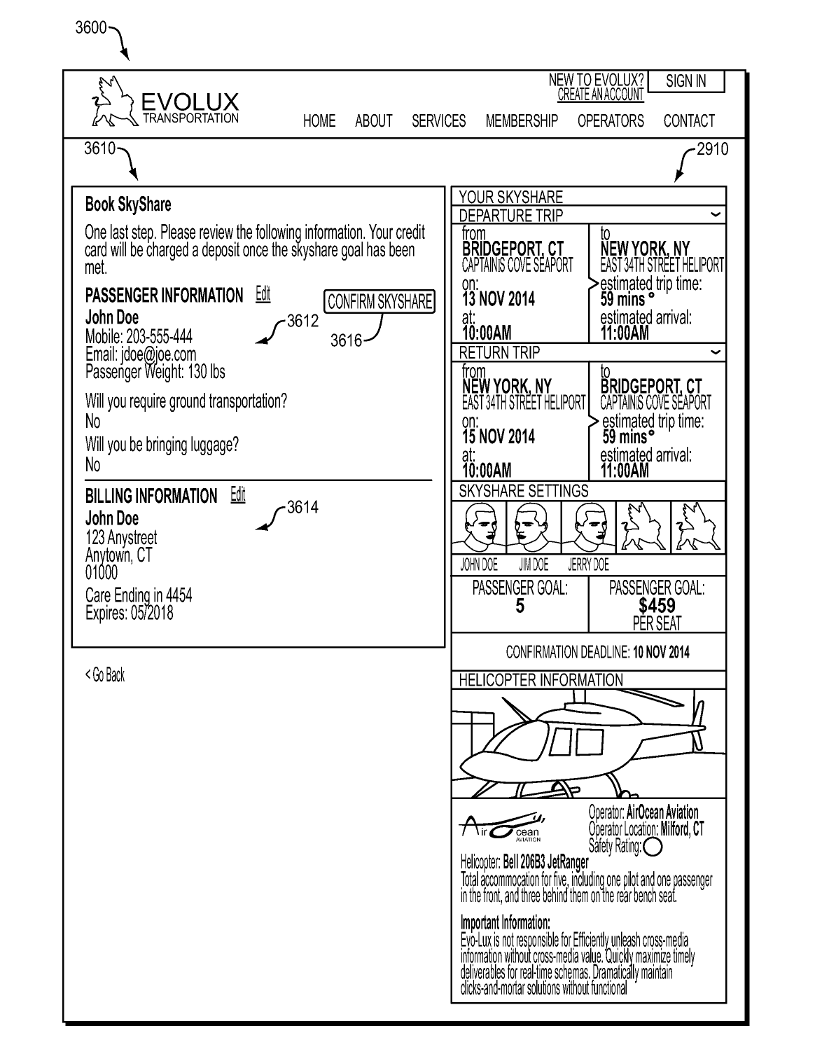

FIG. 34 is an exemplary GUI 3400 that can be provided by an exemplary embodiment of the environment 100 (e.g., via the user interface 110) to allow a member to monitor an aggregate booking request. As shown in FIG. 34, the GUI 3400 can provide a data entry area 3410 that includes options 3412 for specifying events for which the environment will notify a member about an aggregate booking request. For example, the options 3412 can be selected by the member to indicate that the member wishes to be notified with respect to an aggregate booking request when someone joins the shared flight, when someone posts a comment on the shared flight, when a specified time period before the aggregate booking request is scheduled to expire, when shared flight criteria has been satisfied, and the like. The member can submit the selected options to the environment 100 upon selection of a button 3416. In response to a selection of the button 3416, the environment 100 (e.g., via the shared transportation engine 430) can be executed to monitor the shared flight for the occurrence of events specified by the member and can be executed to notify the member when any of the specified events occur. The GUI 3400 can be programmed and/or configured to interact with embodiments of the environments 120, 130, and 140 to facilitate monitoring of a shared flight.

FIG. 35 is an exemplary GUI 3500 that can be provided by an exemplary embodiment of the environment 100 (e.g., via the user interface 110) in response to receiving a request from a member to join an existing aggregate booking request. The GUI 3500 can facilitate an interaction between the member and the booking manager 240 such that the booking information received from the member is processed by the booking engine 242 to join an existing aggregate booking request. The GUI 3500 includes a chartered flight information area 2910 that includes information related to an aggregate booking request and a booking information area 3510 including data entry fields to allow the member to enter booking information.

The area 3510 can displayed to request booking information 3512 from the member joining the aggregate booking request. The booking information requested from the member can be entered in data entry fields 3514, 3516, 3518, 3520, and 3522. The data entry field 3514 can allow the member joining the aggregate booking request to specify shared flight criteria that must be satisfied the member joining the shared flight allows the environment 100 to book the flight (e.g., until a minimum or threshold number of passengers join the aggregate booking or until a maximum or threshold per-seat price is achieved). The data entry field 3516 can request passenger information (e.g., name, phone number, e-mail address, weight, and the like), and can allow the member to enter passenger information for additional passengers upon selection of the data entry field 3518. The area 3510 can include data entry fields 3520 and 3522 to determine whether the member will require ground transportation and whether the member intends to bring luggage. After providing the booking information 3510, the member can select the submit button 3524 to navigate to another GUI to allow the member to enter payment information.

FIG. 36 is an exemplary GUI 3600 that can be provided by an exemplary embodiment of the environment 100 (e.g., via the user interface 110) to allow a member to join an aggregate booking request. The GUI 3600 includes the informational area 2910 and a confirmation area 3610 including data output areas to allow the member to review and confirm billing and payment information previously entered by the member. The area 3610 can display passenger information 3612 based on the passenger information previously entered by the member and can display the payment information 3614 previously entered by the member. The member can select a button 3616 to join the existing aggregate booking request. The GUI 3600 can be programmed and/or configured to interact with embodiments of the environments 120, 130, and/or 140 to facilitate joining an aggregate booking request for a chartered aircraft to be used for a possible non-scheduled chartered flight. For example, in response to a selection of the button 3616 in GUI 3600 of FIG. 36, the booking manager 240 of the administrator environment 120 can add the member to a list of passengers for the aggregate booking request.

After a member joins the aggregate booking request (e.g., upon selection of the button 3616), the number of members included in the aggregate booking request can be incremented. When the number of members that joined booking request (or the price per seat) satisfies the shared flight criteria specified by creator of the aggregate booking request and/or by each of the members that joined the aggregate booking request, the aggregate booking request can be submitted to the operator for review and acceptance of the aggregate booking request. For example, when the shared flight criteria specified by each of the members (or each of the joining members, but not the creator of the aggregate booking request) have been satisfied, the link 3236 shown in FIG. 32 can be active to allow the member that created the aggregate booking request (or a member that joined the aggregate booking request) to submit the aggregate booking request to the booking engine 242, which can present the aggregate booking request to the operator for review and acceptance (e.g., GUI 1700 shown in FIG. 17). After the operator accepts the aggregate booking request, the members can receive confirmation of the shared flight and their payment information, which was previously submitted, can be processed to charge the members for the shared flight.

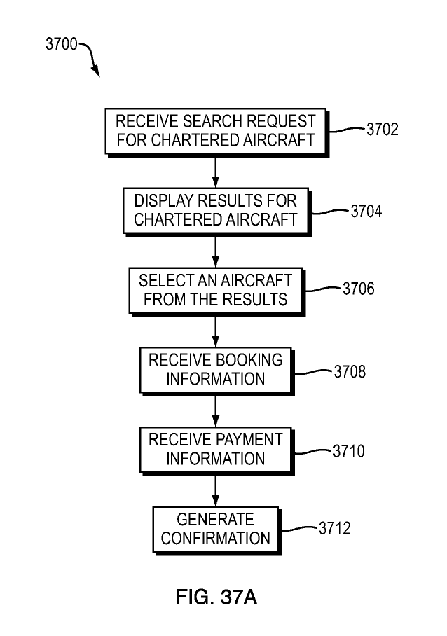

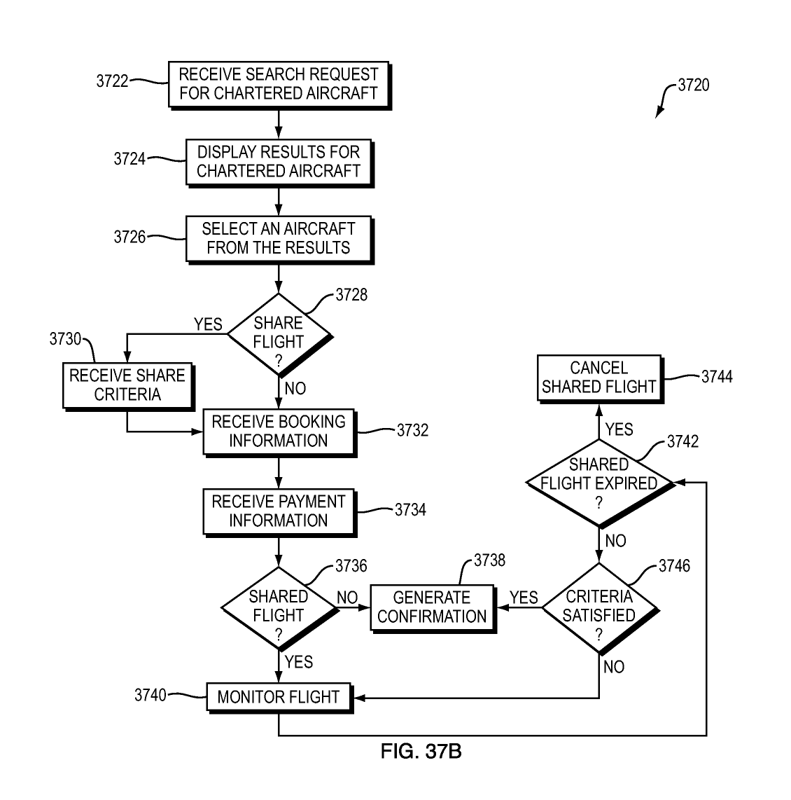

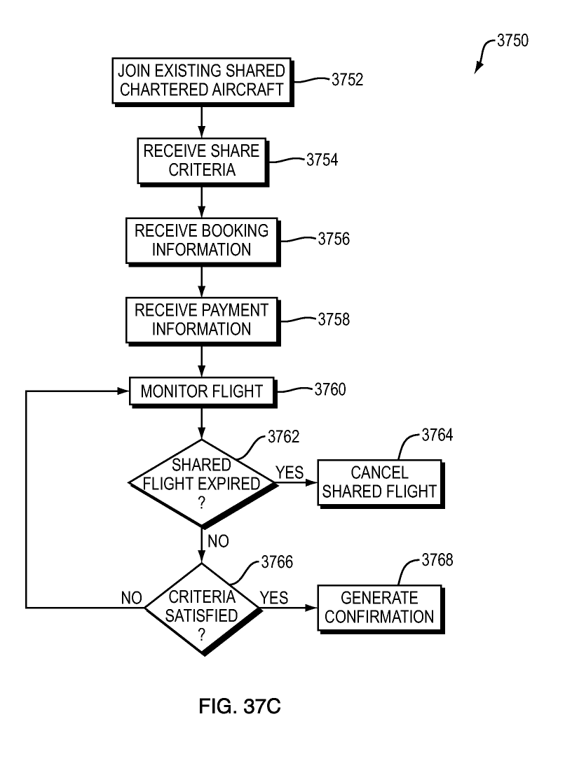

FIG. 37A is a flowchart showing an exemplary process 3700 for booking a chartered flight in accordance with exemplary embodiments of the present disclosure upon execution of code by a processing device. At step 3702 the environment 100 can be programmed and/or configured to receive a search request from a member for available chartered aircrafts. The request can include search criteria including a departure location, at least one destination location, a number of passengers, a departure date and time, a weight of each passenger, and the like. In response to the request, code can be executed to construct a query for search one or more databases for available chartered aircrafts that best fit the received search criteria. In addition, a price for the chartered aircraft being included in the results can be determined At step 3704, the environment 100 can return the results of the search to the member. The results returned by the environment 100 can include a list of possible aircraft that can be chartered by the member. Each result provided in the list can include an aircraft type or class being used for the flight, a location at which the aircraft will be for a requested departure date, departure time, a flight time, a price for chartering the entire aircraft, a price for chartering seat on the aircraft, and the like.

At step 3706, the environment 100 can receive a selection of one of the aircraft returned by the search. In the present embodiment, the member can select to charter the entire aircraft and the environment 100 can provide a GUI through which booking information can be received from the member at step 3708 and payment information can be received at step 3710. At step 3712, code can be executed for the environment 100 to confirm the flight and booking information with the aircraft operator, and at step 3714 a confirmation can output to the member indicating that the chartered aircraft has been reserved.

FIG. 37B is a flowchart showing an exemplary process 3720 for booking a chartered flight in accordance with exemplary embodiments of the present disclosure upon execution of code by a processing device. At step 3722 the environment 100 can be programmed and/or configured to receive a search request from a member for available aircrafts to be chartered. At step 3724, the environment 100 can return the results of the search to the member. At step 3726, the environment 100 can receive a selection of one of the aircrafts returned by the search including a selection of whether the member wishes to charter the entire aircraft, or to charter one or more seats on the aircraft and to share the possible flight with other members. In response to determining that the user has selected to share the possible flight at step 3728, code for the environment 100 can be executed to request and receive shared flight criteria from the member at step 3730. The shared flight criteria can include, for example a goal or threshold number of passenger that must join the aggregate booking request before the aggregate booking request to charter the aircraft is presented to the operator of the aircraft and/or a time period within which other passengers must join the aggregate booking request. Steps 3732 and 3734 can be executed to receive booking information from the member regardless of whether the member choose to charter the entire aircraft or to share the aircraft. At step 3736, the environment determines whether the booking request corresponds to an aggregate booking request. If not, the environment 100 can be executed to confirm the non-aggregate booking request with the operator to book the aircraft for non-scheduled chartered transportation, and to generate a confirmation that is output to the member at step 3738. If the environment determines that the booking request corresponds to an aggregate booking request, the environment 100 can monitor the aggregate booking request at step 3740 and can determine whether the aggregate booking request has expired at step 3742. If the aggregate booking request has expired, the aggregate booking request can be canceled at step 3743. If the aggregate booking request has not expired, code for the environment 100 can be executed to determine whether the shared flight criteria has been satisfied. If not, the process 3720 repeats at step 3740. If the shared flight criteria has been satisfied, the process 3720 proceeds to step 3738.

FIG. 37C is a flowchart showing an exemplary process 3750 for booking a chartered flight in accordance with exemplary embodiments of the present disclosure upon execution of code by a processing device. At step 3752, the environment 100 can provide a member with existing aggregate booking requests and can receive a selection of one of the aggregate booking requests by the member to join an existing aggregate booking request for an aircraft. At step 3754, code for the environment 100 can be executed to request and receive shared flight criteria from the member. The shared flight criteria can include, for example a goal or threshold number of passenger that must join the aggregate booking request before the shared flight is booked and/or a time period within which other passengers must join the shared flight. Steps 3756 and 3758 can be executed to receive booking information from the member. At step 3760, the environment 100 can monitor the aggregate booking request and determine whether the aggregate booking request has expired at step 3762. If the aggregate booking request has expired, the aggregate booking request can be canceled at step 3764. If the shared flight criteria has not expired, code for the environment 100 can be executed to determine whether the shared flight criteria has been satisfied. If not, the process 3720 repeats at step 3760. If the shared flight criteria has been satisfied, the process 3720 proceeds to step 3766 to generate confirmation that is output to the member indicating that the aggregate booking request has been submitted to the operator of the aircraft.

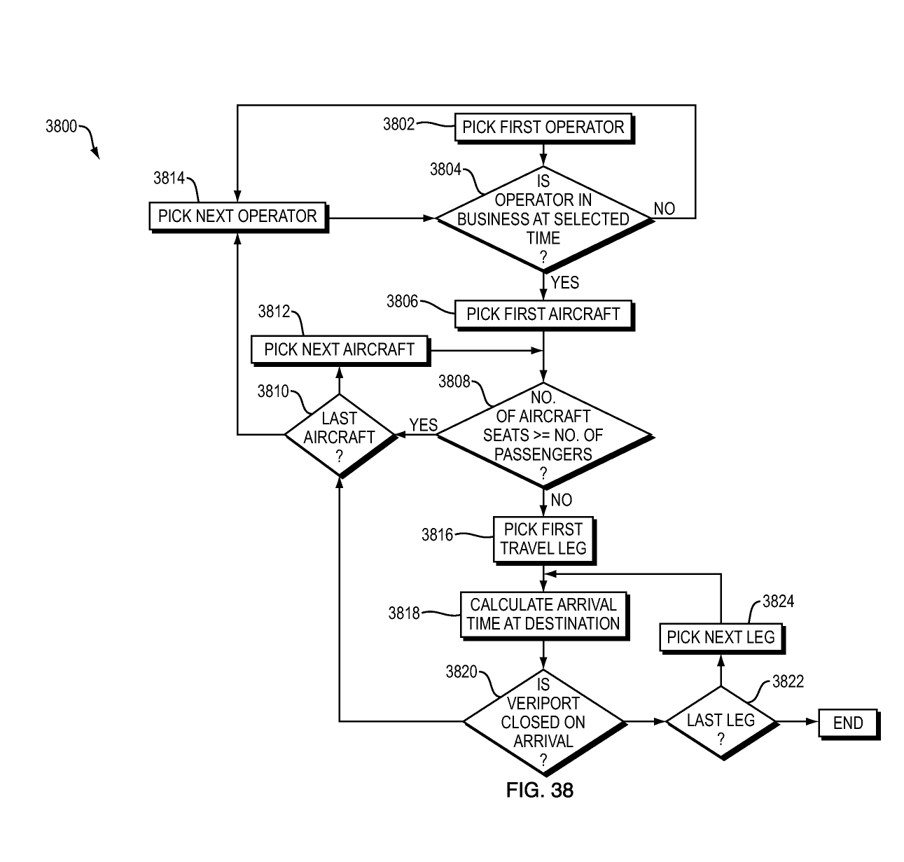

FIG. 38 is a flowchart showing an exemplary search result generation process 3800 that can be implemented in accordance with exemplary embodiments of the present disclosure upon execution of code by a processing device. At step 3802, in response to receipt of search criteria, the environment 100 can be executed to select a first operator from a database storing operator information. At step 3804, the environment 100 can be executed to determine whether the operator has any available aircraft that can be chartered by a member corresponds to the search criteria (e.g., that matches or is a close to the information specified in the search criteria). If not, the process proceeds to step 3814 to select the next operator from the database and then proceeds to step 3804 again. If the operator has aircraft available to be chartered, aircraft information is retrieve from a database that stores the aircraft information at step 3806. At step 3808, the environment 100 is executed to determine whether a number of seats in the aircraft is greater than or equal to a number of passengers included in the search criteria. If not, the process is executed to check whether there are any other aircrafts available from the operator at step 3810. If there are additional aircraft available, aircraft information for the next aircraft is retrieved from the database at step 3812 and the process proceeds at step 3808. If there are no more available aircrafts associated with the operator, the process repeats from step 3814.

When it is determined that the number of aircraft seats is greater than the number of passengers at step 3808, the process continues at step 3816 to select a travel leg for the aircraft and at step 3818 to process is executed to calculate an arrival time at a destination location (e.g., arrival location) that corresponds to a destination location specified in the search criteria (e.g., that matches or is close to the destination location specified in the search criteria). At step 3820, the environment 100 is executed to determine whether a landing area at the destination will be closed at the calculated arrival time. If so, the process 3800 repeats from step 3810. Otherwise, the environment 100 is executed to determine whether there are any other travel legs at step 3822. If so, the next leg is selected at step 3824 and the process repeats from step 3818 for the next leg. If not, the process 3800 ends.

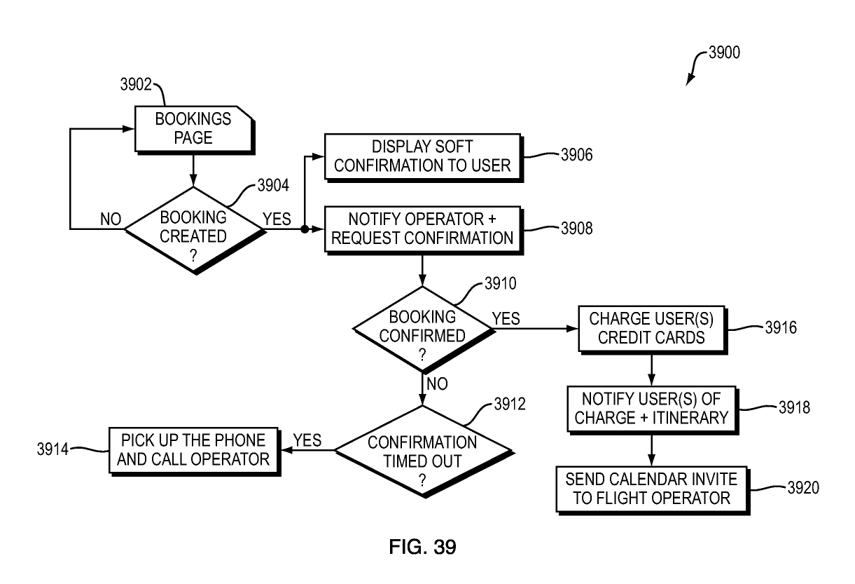

FIG. 39 is a flowchart showing an exemplary non-scheduled charter flight booking process 3900 that can be implemented in accordance with exemplary embodiments of the present disclosure upon execution of code by a processing device. At step 3902, one or more GUIs can be rendered on a display that allow a member to enter booking and payment information. At step 3904, the code for the environment 100 can be executed to determine whether a booking has been created via the one or more GUIs. If not, the process returns to step 3902. If so, the process continues at steps 3906 to generate and display a soft confirmation to the member and at step 3908 to notify the operator of the booking and request that the operator confirm the booking. At step 3910, the process can be executed to determine whether the booking has been confirmed by the operator. If not, the process can be executed to determine whether the confirmation has expired at step 3912. If the confirmation has expired, the operator can be contacted. If the confirmation has not expired, the process returns to step 3910. If it is determined that the operator confirmed the booking, the member can be charged the booking fee at step 3916, and can be notified of the charge and trip itinerary at step 3918. At step 3920, a calendar invite can be sent to the operator.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1-57. (canceled)

58. A method in a multi-user distributed environment, the method comprising:
creating an aggregate request in response to input from a first user received in the multi-user distributed environment, the aggregate request being associated with a shared criteria;
receiving input from at least a second user in the multi-user distributed environment to join the aggregate request to with the first user;
associating the input from the at least the second user with the aggregate request;
determining whether the shared criteria is satisfied in response to the input from the second user;
in response to the shared criteria being satisfied, triggering communication of the aggregate request to a third user in the multi-user distributed environment; and
in response to the shared criteria failing to be satisfied, preventing communication of the aggregate request to the third user.

59. The method of claim 58, wherein the shared criteria comprises a minimum number of users required to join the aggregate request.

60. The method of claim 58, further comprising:
distributing the aggregate request to a fourth user based on a relationship between the first user and the fourth user.

61. The method of claim 60, wherein the relationship is an association between the first user and the fourth user formed on a social media site.

62. The method of claim 60, wherein the relationship corresponds to an established association between the first and fourth users in the multi-user distributed environment.

63. The method of claim 58, further comprising:
executing code to provide a graphical user interface for receiving one or more electronic comments associated with the aggregate request.

64. The method of claim 63, wherein the comments are received from at least one the first user, the at least one other user, or further user that have not joined the aggregate booking request.

65. The method of claim 58, wherein the aggregate request is for shared transportation and the aggregate further specifies an aircraft to be chartered and an operator of the aircraft, the third user being the operator.

66. The method of claim 58, further comprising:
receiving search criteria from the first user in the multi-user distributed environment, the search criteria including a first proposed location, a first proposed date, and a first proposed time;
executing code to search one or more databases for information based on the search criteria;
rendering a result of the search in a graphical user interface, the result including the information associated with aircraft available for the shared transportation; and
receiving a selection of the information associated with one of the aircraft in the result.

67. A multi-user distributed system comprising
one or more non-transitory computer-readable medium storing instructions for implementing a multi-user distributed environment;
one or more processing devices programmed to execute the instructions to:
creating an aggregate request in response to input from a first user received in the multi-user distributed environment, the aggregate request being associated with a shared criteria;
receiving input from at least a second user in the multi-user distributed environment to join the aggregate request to with the first user;
associating the input from the at least the second user with the aggregate request;
determining whether the shared criteria is satisfied in response to the input from the second user;
in response to the shared criteria being satisfied, triggering communication of the aggregate request to a third user in the multi-user distributed environment; and
in response to the shared criteria failing to be satisfied, preventing communication of the aggregate request to the third user.

68. The system of claim 67, wherein the shared criteria comprises a minimum number of users required to join the aggregate request.

69. The system of claim 67, one or more processing devices programmed to execute the instructions to:
distribute the aggregate request to a fourth user based on a relationship between the first user and the fourth user.

70. The system of claim 69, wherein the relationship is an association between the first user and the fourth user formed on a social media site.

71. The system of claim 69, wherein the relationship corresponds to an established association between the first and fourth user in the multi-user distributed environment.

72. The system of claim 67, one or more processing devices programmed to execute the instructions to:
provide a graphical user interface for receiving one or more comments associated with the aggregate request.

73. The system of claim 72, wherein the comments are received from at least one the first user, the second user, or the fourth user.

74. A computer implemented method in multi-user distributed environment, the method comprising:
receiving an electronic request in the multi-user distributed environment including at least one computing device configured to process the electronic request;
executing code to determine whether the electronic request is an aggregate request;
executing a first computer-implemented process in response to a determination that the electronic request is an aggregate request; and
executing a second computer-implemented process in response to a determination that the electronic request is not an aggregate request.

75. The method of claim 74, wherein execution of the first computer-implemented process prevents communication of the electronic request to a specified user in response to determining that the electronic request is an aggregate request and that a shared criteria has not been satisfied.

76. The method of claim 74, wherein execution of the first computer-implemented process triggers communication of the electronic request to a specified user in response to determining that the electronic request is an aggregate request and that a shared criteria has been satisfied.

77. The method of claim 74, wherein execution of the second computer-implemented process triggers communication of the electronic request to a specified user in response to determining that the electronic request is not an aggregate request.
